(19) United States
(12) Patent Application Publication
(10) Pub. No.: US 2018/0068350 A1
(43) Pub. Date: Mar. 8, 2018

(54) AUTOMATED METHOD FOR ALLOCATION OF ADVERTISING EXPENDITURES TO MAXIMIZE PERFORMANCE THROUGH LOOK-ALIKE CUSTOMER ACQUISITION

(71) Applicant: Scientific Revenue, Inc., San Mateo, CA (US)

(72) Inventor: William Grosso, San Mateo, CA (US)

(21) Appl. No.: 15/691,366

(22) Filed: Aug. 30, 2017

Related U.S. Application Data
(60) Provisional application No. 62/495,111, filed on Sep. 2, 2016.

(51) Int. Cl. G06Q 30/02

(52) U.S. Cl. CPC G06Q 30/0269; G06Q 30/0261; G06Q 30/0255; G06Q 30/0204; G06Q 30/0249; G06Q 30/0267

(57) ABSTRACT

Systems and methods for optimizing allocation of advertising expenditures for online commerce, comprising dividing a population of users of an online game or service into a number of logical segments for analysis and optimization, linking said users to the other Internet locations where the advertisements were placed that led those users to the online game or service being optimized, automatically evaluating the value of those users from those Internet sources, identifying the most valuable users, determining which sources deliver those users, increasing the advertising efforts that deliver high-value users, decreasing the advertising efforts that deliver lower-value users, and thereby automatically improving the overall performance of the game or service.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

The present invention is in the field of automated dynamic optimization in online commerce. More particularly, it presents a method for dividing a population of users of an online game or service into a number of logical segments for analysis and optimization, linking said users to the other Internet locations where the advertisements were placed that led those users to the online game or service being optimized, automatically evaluating the value of those users from those Internet sources, identifying the most valuable users, determining which sources deliver those users, increasing the advertising efforts that deliver high-value users, decreasing the advertising efforts that deliver lower-value users, and thereby automatically improving the overall performance of the game or service.

Online commerce differs from the world of traditional commerce in a variety of significant ways. One important difference is that online sellers may be able to sell digital and other virtual goods. Virtual goods are non-physical objects and currencies purchased for use in online communities, digital entertainment applications, online games, or, more generally, digital applications (viz “credits” in a cloud computing model). Digital goods may be a broader category including digital books, audio and video programming and the like.

Another important difference is that the online seller of goods, especially in the world of mobile devices, is likely to have vastly greater information about individual shoppers than will be possessed by a bricks-and-mortar seller such as, for example, a department store in a shopping mall.

Another important distinction between online commerce contexts such as online games on the one hand and most brick-and-mortar contexts is that the average transaction in virtual online commerce is usually small relative to the purchase of an airline ticket. But there may be a larger number of such small transactions, including serial purchases from individual consumers, which may take the form of “impulse purchases.”

Another important distinction is the ready availability of large quantities of data about actual and potential customers—data that can give a seller tremendous insights into the preferences, habits and behavior of those people. For the vast majority of online users, and particularly in the case of users of mobile devices such as smart phones, websites and mobile applications are able to collect information that can give a savvy seller useful insight into the likely behavior of actual and potential customers. That information can be absolute—that is, details about a specific user that are valuable even in the absence of information about other users, or it can be relative—that is, meaningful because it compares a given user to others.

These kinds of data mining opportunities have given rise to techniques that allow advertisers to gain new insights into the performance of various approaches to advertising. The ability to track which advertisements a specific customer has seen (and acted on) has been recognized as valuable for many years. The value comes from what an advertiser could do with perfect insight into this attribute.

Thirty years ago a consumer products company might have placed print ads in Sports Illustrated, Newsweek, Better Homes and Gardens and Cosmopolitan. But it would have been difficult to determine which of those ads generated the most value, because there was no reliable way to tie a sale back to the specific ad that the consumer saw that eventually led to that sale. Thus decisions about how to allocate advertising budgets in the future were largely based on hunches and intuition, not hard data.

Perhaps the oldest technique for dealing with this issue is to print coupons within a physical advertisement. Coupons can help a seller capture useful information about where the ad was printed. But coupons can give rise to many types of fraud and are highly regulated. They also convey information only about where they were printed; they do not give information about the person using it. There also tends to be a selection bias toward specific types of customers—a group that may be a poor fit for the product and its target market. And finally, coupons may be an expensive technique for acquiring data.

Another technique that advertisers have used to attempt to address this shortcoming is to offer coded ad-specific discounts. For example, a company could place an ad in the New York Times that contains words that offer a ten percent discount if a consumer mentions the code NYT10 when placing an order. While this technique does give the seller some information, it has numerous drawbacks: only a small percentage of customers are likely to remember to use the code, which may bias the data in ways that are difficult to correct for; the seller must offer a substantial discount as a way of purchasing the information; and (at least in the bricks and mortar context) there may be no guarantee that the marketing data will reach the people within the organization who most desire it. This technique has also been used in online commerce, which ameliorates some but not all of its drawbacks, particularly when the customer is encouraged to enter the discount code on the online order form.

Techniques have evolved in the world of online commerce to dramatically increase the ease with which information can be obtained about both the customer and the advertisement that led her to make a given purchase. Web advertising has been sold on a “per click” basis for many years—that is, it has been possible to keep track of how many times an ad has been seen. While this information is useful, it is far more valuable to be able to map ad impressions to actual purchasing behavior.

Modern browser technology permits advertisers to track things like the website a person viewed immediately before and after viewing an ad, as well as considerable information about the device being used to view it, geographic location, and many other attributes. These techniques mean that it is now possible for a seller to know much more about the behavior of its customers.

More recently, it has also become possible to use data collected by a browser or other software resident on a computer or mobile device such as a smart phone or tablet to track back from an actual purchaser to the advertisements that purchaser viewed prior to making the purchase. All mobile devices have a persistent unique identifier akin to a serial number. Some mobile devices and operating systems make the device-specific unique identifier accessible to web browsers and other applications such as games. However, more recently many device and operating systems have enable the creation of changeable ID numbers. For example, mobile devices from Apple Inc. now utilize a technology called IDFA (ID For Advertisers) that enables the collection of very detailed information, but permits a user to reset the IDFA, or to restrict or opt out of tracking entirely. Apple no longer permits advertisers to access the persistent ID number. The Android operating system created and maintained by Google, Inc. offers similar functionality.

These technologies have enabled the evolution of a new ecosystem for efficient use of marketing investment for certain products. Specifically, they enable performance advertising for applications that derive revenue from in-application purchases (“IAP”). This business is also known as acquisition advertising or cost-per-install (“CPI”) based advertising.

In the world of mobile-based games, there are a relatively small number of financially large and successful properties—games that generate enough revenue from in-application purchases of virtual goods used within the universe of that game that they are self-sustaining and profitable. There is a much larger universe of other games that have fewer users and are less financially viable based on activity within their own ecosystems. This situation has created a mutually beneficial opportunity: larger games have marketing budgets that they wish to spend on acquiring additional users. Smaller games seeking additional revenues have begun to sell advertising space within their properties. Unsurprisingly, people who have downloaded and played mobile games are a desirable audience from the perspective of advertisers promoting other mobile games. And at least in some cases, it has been shown that in-game advertising is cost effective both from the perspective of the advertisers and from the perspective the sellers of the space used for the ads. Thus sophisticated systems have rapidly evolved to maintain a fairly efficient marketplace for the buying and selling of such ads. Similar situations exist in other software ecosystems. For example, in the world of dating applications, the current dominant players, Tinder and Match.com, are major purchasers of advertising placed within smaller, less intrinsically profitable dating applications. However, relative to mobile gaming, these advertising ecosystems tend to be smaller, either because the average value per user in those areas is smaller or because in-application purchases are less common in non-gaming applications. Although multiple separate individual advertising systems exist, it is relatively unusual for them to intersect; that is dating applications rarely advertise in games and vice versa.

One type of actor that has developed to facilitate such commerce is the ad network. Ad networks provide a means by which games or other applications that wish to find additional revenue sources (sometimes known as the “sell side”) can be paired with games that seek to buy additional users (known as the “buy side”) with minimal transactions costs. There are currently hundreds of such ad networks, but among the largest today are Facebook, Twitter, InMobi and Applovin.

When a sell-side game seeks to offer to sell ad space within its property, it may permit one or more ad networks to install software within its game. This software performs several functions that are essential to the functioning of the advertising marketplace. The ad network software (generally thought of as an SDK) has the ability to collect data from the device on which it is installed, including the unique identifier of the device (which, as described above, may be in the form of an IDFA). This information is retrieved from each individual device and stored in a database or similar data storage architecture managed by or for the ad network. The sell side game provider also specifies locations within the game in which it is willing to display ads, and creates blank digital “billboards” to be filled by the ad network. When a buy side game seeks to acquire more users through paid advertising, the buy side game creates (or has created for them) the creative content that is to be placed on the virtual billboards, and places an order with the ad network. Historically, such orders were specified in terms of the number of impressions generated; that is the number of times consumers were shown a given ad. More recently, as the ability to track users has evolved, the typical means for specifying a purchase of advertising has become performance-based. Thus a mobile game might place an order for 500 installs (that is, people who not only see the advertisement, but actually act after seeing it and proceed to accept the call to action and download the game to their devices) rather than a much larger number of impressions. In some cases, such orders may also specify additional parameters, such as broad-brush location (e.g., from a given country or countries) or the presence of another specified game or application on the same device.

The reason IDFAs and other device ID methods are important is that payment is generally made to the sell side based on performance: specifically, based on the number of users who actually install the buy-side game after seeing the ad on the sell-side property. As with many forms of advertising, it is likely that an individual will see multiple ads for a game before responding. And it is also likely that a typical viewer will see ads for given buy-side game on multiple sell-side games before responding. This creates potential challenges regarding proper attribution and thus payment. IDFAs and other similar tracking systems permit ad networks to determine which ads were presented to a given user, so that if hypothetical user XYZ123 downloads buy-side game “Bobbing for Apples”, the advertising network will know that she did so after seeing 3 ads in two different sell-side games over the previous week. Although a variety of potential methods for allocating the credit for the deal are possible, in practice, 100% of the credit is generally given to the last ad seen prior to downloading of the buy-side game. Thus it is also important that the target device capture and transmit to the ad network server the time when each ad was viewed.

While ad networks are able to acquire significant information about the end users who view ads and download games as a result, in general this information is not made available to the companies buying the ads. This opacity limits the cost-effectiveness of their advertising, because the ability of advertisers to target specific kinds of users is limited. Thus the pairing of blank billboards with advertisements is not very sophisticated in this model. Additional variables are often added in practice because a given sell-side game may include multiple ad network SDKs, and may allocate given ad slots randomly. This limitation may adversely affect both sides of the transaction, because the ability to target users could increase the amount a buyer will pay for a specific advertising opportunity.

In general, the ad network-based marketplace is relatively static and low-resolution in terms of ad pricing. Many aspects of the process remain somewhat ad hoc and subject to negotiation. Thus a seller of advertising space may list various advertising properties for sale, advertisers effectively browse those properties, and may even seek to haggle with the seller for a better price. Thus transactions costs can be quite high for this approach.

From the standpoint of a game provider, the ad network market can be complicated and time-consuming to manage. And as previously described, it is sub-optimal in its targeting of advertising. Thus a second form of service provider has appeared: the network aggregator. Network aggregators intermediate between sell-side properties and ad networks. Where an individual sell-side game might be able to contract with only a handful of individual ad networks (both because of transactions costs, and because adding a large number of ad network SDKs to a game can materially affect both the time required to download the game and the quality of the user experience), contracting with a single network aggregator offers several advantages. First, it simplifies the process for the sell-side provider, as it can deal with a single vendor while being exposed to a very large number of potential buy-side opportunities. Second, network aggregators have instituted more sophisticated systems that permit techniques including real-time bidding and demographic bidding. Thus buy-side customers who place ads through aggregators can place performance-based bids for their desired results (e.g., paying a specific dollar amount for each new customer who installs their game, usually up to a capped number of customer acquisitions), and the aggregator then places ads with sell-side participants until the desired number of customers have been acquired for the buy-side customer. More specifically, many aggregators use software applications that allow an ad buyer to place bids for a specified number of users with a set of demographic characteristics—e.g., 1000 users who have at least two of a specified list of other games already installed and whose phones are based in a specified country or countries—and the bid will reflect that the buyer is willing to pay a CPI (cost per install) of $1.50. Ad sellers then respond by accepting the buyer's offer as to some or all of the buyer's bid. In general a contract is established by the seller when it accepts the buyer's bid, and further negotiation is neither necessary nor even enabled. Leading network aggregators are Chartboost and Unity. A fundamental shift inherent in this newer model is the shift in responsibility for understanding the effectiveness and thus the yield of installs relative to the number of impressions. When an advertiser buys impressions, it is possible for the advertiser to get everything that it paid for (say, 100,000 impressions) but nothing it actually wanted (zero new customers). Thus in impression-based advertising the ad buyer assumes the risk that the ads will not deliver real results. However, when buying on a cost-per-install basis, the buyer pays only for positive outcomes, and it is the seller that bears the risk that a large number of impressions will yield fewer installs, and thus less payment to the ad seller. It is possible that advertising models will evolve further still, so that, for example, advertisers will pay only for users who go even further than just installing a game or other application, and pay only if, for example, a user actually goes on to use the application a specified number of times or play the game for prescribed length of time.

Another aspect of the aggregator business model is that it places an additional layer between ad buyer and ad seller. This intermediation can result in the obfuscation of data that an advertiser might find useful. Thus while some aggregators will inform buyers who is selling a given ad, others do not.

One challenge created by the advent of network aggregators is that it becomes more complicated to resolve attribution: when a buyer places an order through an aggregator that works through multiple ad networks and a potentially large number of individual sellers, figuring out which advertiser should be credited for a specific install can be very complicated. Thus a third category of service providers has emerged: the attribution provider. Attribution providers seek to deliver credible accounting for the complex process of determining which sell-side participant is entitled to payment for each new customer acquired. Ad networks that work with an attribution provider permit the attribution provider to install an SDK on the server of the ad network. Another SDK connected to the servers of the same attribution provider runs on the device of the consumer who installs a game that has been provided by a buyer of advertising. When a customer installs the game, the SDK on the end-user's device reports to the attribution provider's servers that the game has been installed on the device with a specific IDFA or similar identifier. The attribution provider's servers then match up this IDFA with the lists of IDFAs resident on the ad network servers where the buy-side game has been advertised, and finds the record for the last advertisement that was served to that IDFA prior to installation, and attributes the customer acquisition to that ad. In some cases, no attribution is given, such as when too much time has elapsed between the last ad viewing by a given end user and the downloading of the game.

One of the desirable things that these systems can enable is targeted advertising. In the early days of the Internet commerce, advertisers bought banner ads that might be served to all visitors to a given website. But this approach has well-understood drawbacks. Such broad advertising approaches are likely to place ads in front of customers who are extremely unlikely to buy the product being advertised. And such indiscriminate placement also contributes to the tendency of consumers to ignore the ads, which reduces their value to both advertisers and the sellers of the ad space.

Targeting has the potential to increase the relevance of the ads to consumers, increase the effectiveness of a given ad campaign, and increase the value of (at least some) advertising locations.

In order to target ads, it is necessary to know something about who is viewing the ad. The most primitive advertising targeting is what has been used in print and broadcasting media for decades: the readers of Cosmopolitan magazine and viewers of soap operas were primarily women, and so advertisers for products targeted toward men went elsewhere. But traditional methods did not permit advertisers make more than such coarse statistical inferences: there was no way to know anything about a specific consumer viewing an ad.

Internet-based advertising has progressed beyond this level. Desktop and mobile browsers collect considerable data about individual users, as do mobile applications such as games. In addition to enabling performance-based advertising as described above, the information gathered permits advertisers to target recipients based on increasingly complex criteria. Thus it has been possible for several years to target web and mobile advertising geographically, because browsers can generally determine approximate location based upon information like IP address, and mobile applications can leverage multiple data points regarding the location of a mobile device. It has also been possible to target by other rough demographic parameters, as previously discussed.

These targeting techniques are generally superior to untargeted approaches, but they have significant limitations. Perhaps most significantly, in order to employ them, an advertiser must know up front the answer to several important questions, including (a) the profile of the desired customer, and (b) where to find them. The first question may seem obvious for some products (e.g., wealthy people for expensive automobiles or new parents for diapers), but for products like mobile games, the answers may not be as simple. And even for products that have obvious user profiles, selecting cost-effective places in which to advertise to them may be challenging.

Recent advances in technology have permitted advertisers to begin to employ machine learning techniques to optimize advertising expenditures in the absence of a priori human insight into the demographic characteristics of the ideal customer. One technique that has been developed is sometimes known as look-alike advertising. When an advertiser such as a mobile game vendor wishes to acquire new customers using look-alike advertising, the advertiser selects a group of existing customers that have proven to be valuable to the advertiser on whatever metric or metrics are most relevant to that game provider (e.g., lifetime value, average spend over a given interval, etc.). The game provider then collects the IDFAs for that collection of users, transmits the IDFAs to an advertising network, and in effects says, “get me more users like this.” The advertising network then uses the data available to the advertising network, which includes user data aggregated from the SDK installations on the “sell side” and not generally available to the advertiser, about the users included in the population specified by the selected IDFAs to determine whether there are distinguishing characteristics of that group that would permit a targeted approach to obtaining more of the same. That data is likely to include information about location of the user, the make and model of the mobile device, other games and applications downloaded to the device, etc. Thus analysis may show that the desired users are predominantly from countries (and specific areas within those countries) with relatively affluent people, and/or the newest mobile devices with the largest screens and fastest processors, etc. Once such a profile has been determined by the ad network, the ad network can place ads for the advertised product only on the devices of the chosen population.

For this approach to be effective, in general the target “more like this” group needs to be sufficiently large to permit statistical processing, and the larger the group, the more useful the process will be. The process is also more effective if the target group represents users of proven quality—for example, players of a mobile game who have already engaged with the game enough to have progressed to a relatively challenging level of play.

Thus existing technology enables an advertiser to determine that customer A was referred by advertisement X, while customer B came from advertisement Y. It is also possible to document the purchasing behavior of customer A and customer B. It would be advantageous if an advertiser could utilize an automated process to evaluate these sources of information to determine which ads generated not merely the largest quantity of customers, but the most desirable quality of customers (which is likely to be a function of their spending over time, but could be measured in many ways).

Games and other digital entertainment applications are fundamentally different from brick-and-mortar commerce in many ways, and predictive analysis is still crude particularly with respect to lifecycle analysis and churn prediction. Core ideas can be translated to the gaming industry, such as utilizing an increased role for A/B testing to compensate for a current lack of theoretical models or utilizing machine learning (which has progressed a lot in recent years). Utilizing existing “general purpose” infrastructure such as cloud-based technologies can reduce technological complexity.

Digital entertainment applications are generally not exploring this opportunity, instead focusing on dealing with technological shifts (e.g., the move to mobile devices, incorporating techniques like virtual reality), platform shifts (frequent game console and platform releases/updates), behavioral shifts (players tending away from or toward certain genres or gameplay elements), the emergence of virtual reality, smart televisions, and the like, and basic product or sales management concerns. Analytics are often an afterthought at large game companies, or are out of reach of smaller studios or independent developers.

Service companies aren't solving these concerns, being instead focused on discovery and retention (which are themselves core concerns for game companies), whereas monetization companies focus on advertising.

What is needed is a solution that offers a unified system for reporting, analysis, and administration of advertising optimization, and that should be scalable to accommodate a wide variety of potential use cases or infrastructures so as to facilitate solutions for a wide user base.

### SUMMARY OF THE INVENTION

Accordingly, the inventor has conceived and reduced to practice, in a preferred embodiment of the invention, a system and method or providing a unified, scalable, and user-friendly system and methods for reporting, analysis, and automation of yield optimization with minimal a priori knowledge of the characteristics of the game and its users.

The subject invention can also be used to automatically determine whether and when to present targeted advertisements to users of online applications including but not limited to games where the timing, context and contents of said advertisements are at least in part determined by the activities of the user within the application.

In an embodiment, the subject invention comprises a method for managing the allocation of advertising for a game on a mobile device, comprising evaluating a plurality of attributes of a plurality of existing users of the online game; using the plurality of attributes to divide the plurality of existing users into a plurality of segments; identifying at least a segment of the plurality of users that is correlated with high performance in at least a category of user behavior relative to other segments of users; creating at least a profile of users comprising the segment correlated with high performance; and placing advertisements in order to maximize the acquisition of new users comprising that segment.

In an embodiment, the subject invention comprises a system for increasing the number users who install a game on a mobile device, comprising: a first application running on a first device comprising computer hardware, where that device is in communication with a network; a second application running on a plurality of second devices comprising computer hardware, where the second devices are in communication with the first device over the network; where the first application evaluates a plurality of attributes of a plurality of existing users of the online game on the second devices; where the first application uses the plurality of attributes to divide the plurality of existing users into a plurality of segments; where the first application identifies at least a segment of the plurality of users that is correlated with high performance in at least a category of user behavior relative to other subsets of users; where the first application creates at least a profile of users comprising the segment correlated with high performance; where the first application evaluates the performance of the segment of the plurality of users that has previously been correlated with high performance; and where the first application creates a profile for desired additional users of that game such that those new users correspond to the segment of the plurality of users that has previously been correlated with high performance.

### BRIEF DESCRIPTION OF THE DRAWINGS

The accompanying drawings illustrate several embodiments of aspects of the subject invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 is a block diagram illustrating an exemplary hardware architecture of a computing device used in an embodiment of the invention.

FIG. 2 is a block diagram illustrating an exemplary logical architecture for a client device to be used by an administrator of the subject invention, according to an embodiment of the invention.

FIG. 3 is a block diagram showing an exemplary architectural arrangement of clients, servers, and external services, according to an embodiment of the invention.

FIG. 4 is another block diagram illustrating an exemplary hardware architecture of a computing device used in various embodiments of the invention.

FIG. 5 is a block diagram of an exemplary system architecture for yield optimization, according to a preferred embodiment of the invention.

FIG. 6 is a method diagram illustrating an exemplary method for advertising optimization, according to one embodiment of the invention.

FIG. 7 is a method flow diagram illustrating an exemplary method for segment-based optimization according to a preferred embodiment of the invention.

FIG. 8 is a high-level block diagram of the logical relationship between the applications on an end-device and the advertising optimization server according to a preferred embodiment of the invention.

FIG. 9 is a flowchart illustrating the steps involved in an exemplary process for collecting segmenting data regarding a user of a hypothetical mobile game.

FIG. 10 is a flowchart for an exemplary process for determining the value of a specific advertising source and/or strategy, and using that information to adjust how an advertising budget is allocated.

FIG. 11 is a flowchart illustrating a series of steps involved in an exemplary approach to applying tests to a specific segment.

FIG. 12 is a flowchart illustrating the steps involved in applying one of these tests comprising an exemplary version of the subject invention to two segments.

FIG. 13A through 13I is a table representing hypothetical values for a selected sample of possible user segments and attributes.

FIG. 14 is a flowchart illustrating a series of steps involved in an exemplary approach to determining whether a user segment is correlated with a desirable attribute.

FIG. 15 is a flowchart illustrating a series of steps involved in an exemplary approach to increasing performance through automated optimization.

FIG. 16 shows a method according to the subject invention for discovering the highest price that a buyer should be willing to pay to acquire a user in a particular segment.

FIG. 17 illustrates the steps involved in one application of the subject invention to reduce waste in customer acquisition.

FIG. 18 illustrates the steps involved in applying the subject invention to optimize the size of an offer of free virtual goods in an advertisement for a game for computers or mobile devices by automatically measuring the financial impact of different offers, determining which offers maximize returns, and implementing those value in future ads.

### DETAILED DESCRIPTION OF THE PREFERRED EMBODIMENT

According to a preferred embodiment of the invention, an automated method for allocation of advertising expenditures to maximize the cost-effectiveness of those expenditures may comprise an application server that may provide a web application where e-commerce managers may define segments, a web server that may provide a web-based (such as may be accessible via a web browser on a computing device) interface for interacting with the application server as well as a web-based interface where clients may query for policies and other purposes, a reporting server that may compute aggregate statistics, a segment definition server that computes segment definitions, and an administration server that may contextualize segment metrics for use in reporting operations, is disclosed. Central to all of these is the definition of a “segment”. In order to make the system loosely coupled, and to make it as flexible as possible, the idea of a segment may be defined in terms of a functional language—that is, there is a set of functions, which implicitly take a user as their argument. These are then compared to well-known values, and the results of those comparisons are combined with Boolean operators to yield a truth value (e.g. whether the user is in the segment). This document describes various segmenting functions that may be present according to the invention, and how they may be combined. It does not define the precise syntax of the language, but for the avoidance of doubt, a lisp-like language would be more than sufficient. For example, (=(7_day_time_series (3_day_moving_average number_of_transactions_gold)) MONOTONE_UP) may represent an assertion that a given user's 3 day moving average on their number of transactions has been increasing for the past 7 days. Note that all moving averages are inherently anchored NOW and projected backwards, but the operation of creating a time-series anchors in preceding days.

According to the embodiment, an administration server may be utilized such as to contextualize or normalize metrics reported such as with per-capita, relative, or distribution measurements. Metrics often are recorded as raw numerical data such as “minutes played” being reported in a single active session. When contextualized, this metric data may become, for example, “minutes played per day”, or additionally contextualized for a particular segment. Metrics reported might include a variety of relevant or desirable summary, demographic, revenue, spending, virtual currency, engagement, retention, gameplay, or churn metrics. Such metrics may be reported over time, facilitating use according to a variety of potential administrative actions such as those described above.

From within a report, a user may use an administration tool to make changes and edit information, effecting a blended reporting and administration system. As envisioned, the system of the invention may be adaptable to mobile system architectures and implementations as well as larger, more traditional environments such as desktop computer workstations.

“Wallet-engagement” may be measured according to the invention. A person can play a free-to-play game indefinitely without spending; there are various useful measures of engagement: Is she playing? Acquiring skills? Is she bringing other people on/acting social? Is she interacting with the economy? Ideally, the answers to the other these questions will be correlated; to the extent they're not, an imbalance in the game is thereby identified. If she is playing a lot and spending a lot, but not acquiring skills, she is a churn risk (game is too hard). If she's acquiring skills abnormally quickly, she's a churn risk (game is too easy). If she's playing a lot and acquiring skills, but not spending money, she may have become a long-term freeloader we would like to convert. Such correlations and metrics may become apparent via the reporting and administration functions provided by the system of the invention, as described previously. Spend metrics may also be measured according to the invention, for example by measuring customer lifetime value, or by traditional metrics such as non-engagement with the payment wall (the screen included within an application that presents the prices for various goods), or take-rates on various aspects of the payment wall.

As previously described, the invention may utilize the notion of a “segment”, referring to a user or group of users. “User” may refer to any individual or group using an electronic service or product. The invention may comprise a set of “canned segments”, or preprogrammed sample or dummy segments such as for testing or analysis purposes. Additionally, there may be a means for retiring or recycling segments, effectively updating any sample data or logic within a system. Such canned segments may be generated automatically, may be customizable for specific implementations or for particular users, and may have a set timeframe for data collection and reporting, and may have pricing rules or data associated with them as with a “real” segment, i.e., a human customer.

Regarding segments, the subject invention can include several basic operations. Such operations may include but are not limited to:
Examine segment—this consists of selecting a segment and viewing a wide range of metrics associated with it
Compare a segment today with a past version of itself—given a segment, a user of the subject invention may view data for now and for an arbitrary past timeframe. Such a timeframe may be an absolute date (e.g., data from June 01), a relative date (data from previous three weeks), or other implementations such as configurable time-markers.
Compare multiple segments—similar to comparing against past version, but comparing current data for a plurality of different segments
Compare multiple segments across time—combining previous actions, view data for multiple segments across a timeframe
Restrict report—control who may view what data
Export data—the ability to export report data to other formats

The ability to evaluate and act upon the observed intersection between semantically distinct segments yields potentially powerful results. For example, the ability to segment users of an online game or other service who view a pricelist or paywall the first time they play the game or use the service is likely to indicate which users are interested in making a purchase, but tells the seller very little about their ability to do so. Segmenting users based on indicia of affluence is likely to indicate which users have a high ability to purchase, but little about their desire to do so. But the intersection of these two segments—that is, the segment of users who manifest markers of both intent and ability to spend—is likely to be a fruitful group to target, and the ability to automatically identify and target them will be very useful.

According to a further embodiment of the invention, a client administration server may be used for managing various aspects of a client's program or service. According to the embodiment, the invention may provide such features as merchant services (such as order processing, pricing, or delivery), identity services (such as user or session tracking), game mechanics (such as A/B testing, rewards management, or fraud control), messaging (such as control of form and function of standardized messages such as “thank you” e-mails, or push-based messages or events such as alerts sent to offline users), or a “ledger” service for currency control (that may not be accessible to the public directly, and that may be used similarly for both real-world and virtual currencies). Currency support may comprise a full-featured, cloud-based “wallet”, or optionally the ability to give clients currency administration such as for creation of internal virtual currencies as may be desirable. Additionally, the invention may utilize repudiation handling and wallet updates, such as optionally utilizing push-based wallet updates to ensure synchronicity and validity between wallets if a dispute or discrepancy arises.

According to an embodiment, a client administration server may utilize open-source or other existing frameworks or elements such as for ease of integration with existing components that may already be in use (thereby lowering initial cost to a potential client, both in terms of monetary investment as well as infrastructure concerns). Administration may comprise such features as multi-tenancy and security models (user accounts, administrative access control), or the ability to view various read-only information such as user data (such as names, contact information, non-editable history, or other such information that may be identifiable with users), pricing rules (further described below), policy definitions, segment definitions, and optionally the ability to synchronize data (such as for backup, version control, or synchronicity between multiple copies of similar data), such as is common in the art with cloud-based synchronization or data storage solutions.

It can be appreciated from the above that the invention may take the approach of “closing the loop” between reporting and report-based actions and thus automating such processes. This may utilize such approaches as detailed user models, tools that map user models to various advertising placement options, or reports demonstrating outcomes and suggesting additional actions or improvements.

There is value to the provider of online services, virtual or other digital goods, games, etc. in understanding its customers. Among other things, (improved user experience, etc.) that knowledge can be used to increase revenue by helping the provider to adjust where and when the provider chooses to purchase users through performance-based advertising so as to maximize the number of customers who buy/play, maximize the time (and money) customers spend using the service or playing the game, etc.

While geography is likely to be an important determinant of the value of a given potential user for a given virtual or other digital good, it is not the only one. Providers of virtual or other digital goods such as in-game currencies or software may have access to data that indicates to the provider numerous clues regarding the likely behavior of a given user including:
Whether the user is engaged with the game or service;
The degree to which the user is engaged with the game or service;
Whether the user's pattern of engagement predicts long-term retention'
How recently the user downloaded the game/application;
   and many other factors.

It may be true that one or more of these factors is a strong predictor of the future purchasing preferences and behavior of individual users. But it is very unlikely that a game or service provider will have the data (or the analytical capabilities) to determine which factors are most meaningful for purposes of determining how it should allocate its finite advertising budget.

It would be advantageous to determine the allocation of advertising expenditures empirically, through evaluation of statistical correlation of various observable factors, such as those listed above, with the desired result (generally, increased long-term revenue per user).

Another way of describing the problem addressed by the subject invention is that, as with any business, it is essential for the long-term success of an application such as a mobile game that the provider spend less to acquire a new customer than the provider expects to receive in revenue from that customer. (More specifically, since the outlay to acquire a customer is likely to be incurred before most or all of the value generated from that customer is realized, and because it will be impossible to remove all uncertainty regarding how much a new user will spend, a game or application provider should ensure that the acquisition cost is lower than the cash flow generated as discounted given both the risk that revenue will be lower than anticipated and the time value of money.) But in the prior art, it has generally not been possible to predict the value of a customer. Advertisers have been able to specify broad characteristics that are believed to correlate with spending and long term value, but it has not been possible to accurately predict the value of a user. Nor would it be possible for an advertiser to predict when a given user or group of users would be likely to make a first purchase.

Thus an advertiser could not evaluate the cost-effectiveness of an advertising strategy until well after both the completion of the ad buy and enough time to evaluate historical spending patterns of the specific users obtained from that ad. In some cases that would require that weeks or months would have to elapse before a strategy could be fairly evaluated.

It should also be noted that the value of these kinds of predictions is in a sense greatest in cases in which answers are unexpected. A first-person shooter game provider seeking users for a new mobile game that employs leading-edge graphics is unlikely to need sophisticated predictive analytics to inform it that revenue will be best among players with the most recent high-end smart phones. Nor will that same game provider need help figuring out that it is least likely to sell an expensive in-game “weapon” to players in a poor country who use 3-year-old devices. But if predictive analytics can determine that there is a subset of those seemingly unlikely spenders who exhibit one or more additional characteristics that predispose them to spend money within the game, that information will be of great value. In effect, such insight becomes an arbitrage opportunity, because it permits the “buyer” of those customers to recognize value where the “seller” does not, or to capture value that may be unique to that buyer, and thus by paying only slightly more than what another buyer would pay, the buyer can capture significantly greater value.

It would be advantageous to be able to predict the expected long-term value of a user or group of users, and to target those users only when their expected long-term value exceeds the cost to acquire them.

It should also be noted that the classical economic model of a supply curve and a demand curve implies that there is a single market-clearing price at which all transactions for the exchange of a homogeneous good take place. But players of a game or users of many other forms of virtual goods and services are not in fact homogeneous: some will spend significantly more money than others, some will recruit many other users and some will not, and so on. Thus their value to a specific vendor will vary, which in turn means that the maximum price a vendor should be willing to pay will vary as well. The workings of markets for the buying of advertisements (and, with performance-based pricing, customers) permit buyers to pay different amounts for different users. Thus it would be highly advantageous to apply predictive valuation in order to rationalize the marketing function by minimize spending for new users relative to the profit generated as a consequence of acquiring those users.

It would be advantageous to be able to apply predictive modeling in order to quickly assess the effectiveness of a given advertising approach and thereby enable advertisers to terminate wasteful strategies and focus on strategies that maximize the return on advertising expenditures.

One of the techniques used to acquire customers for applications such as games for mobile devices is to place advertisements that include enticements such as free offers of virtual goods such as in-application virtual goods such as virtual currency. While such enticements may increase the yield of an ad (i.e., increase the number of people who decide to install and play the game after viewing the ad), the enticement, like most offers of “free stuff,” has a downside to the vendor. To the extent the game is generally able to persuade users to exchange real money for the virtual goods, the free loss-leader reduces income. In addition, determining the optimal free offer within such an ad is complex. An ad that does not succeed in enticing potential users to download and play the game is obviously ineffective. But less obvious is the fact that an offer of a large value of virtual goods may adversely affect the perceived value of the game, and may affect game play in ways that erode the long-term value of users

It would be advantageous to offer a means by which the offer of free virtual goods in an advertisement could be optimized by automatically measuring the financial impact of different offers, determining which offers maximize returns, and implementing those value in future ads.

Identifying the key factors that best predict the future purchasing preferences and behavior of individual users generally requires considerable experimentation, testing of behavioral models, etc. Thus developing that insight has been prohibitively expensive for many game and software providers. The long timelines involved even for those who might be able to undertake such an analytical process has cost them valuable time, revenue, and the resources needed to perform such analyses, including the energy needed to power the computers employed in pursuit of that knowledge.

It would be advantageous to provide a method for identifying key factors that best predict the future purchasing preferences and behavior of individual users quickly and automatically.

The inventor has conceived, and reduced to practice, a system and method or providing a unified, scalable, and user-friendly system and methods for reporting, analysis, and subsequent administration of data-driven, as well as methods for rapidly establishing useful segmentation strategies for populations of users or customers when a priori knowledge of the characteristics of those users is limited or absent.

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

A “segment”, as used herein, refers to a real or simulated human user or group of users, such as may interact with or operate electronic devices or services. Such segments may be the subject of price optimization or other operations, several exemplary types of which are described below.

A “canned” segment, as used herein, refers to preprogrammed sample or dummy segments such as for testing or analysis purposes, such simulated segments ideally operating and behaving in a manner as closely simulating real human users as possible.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

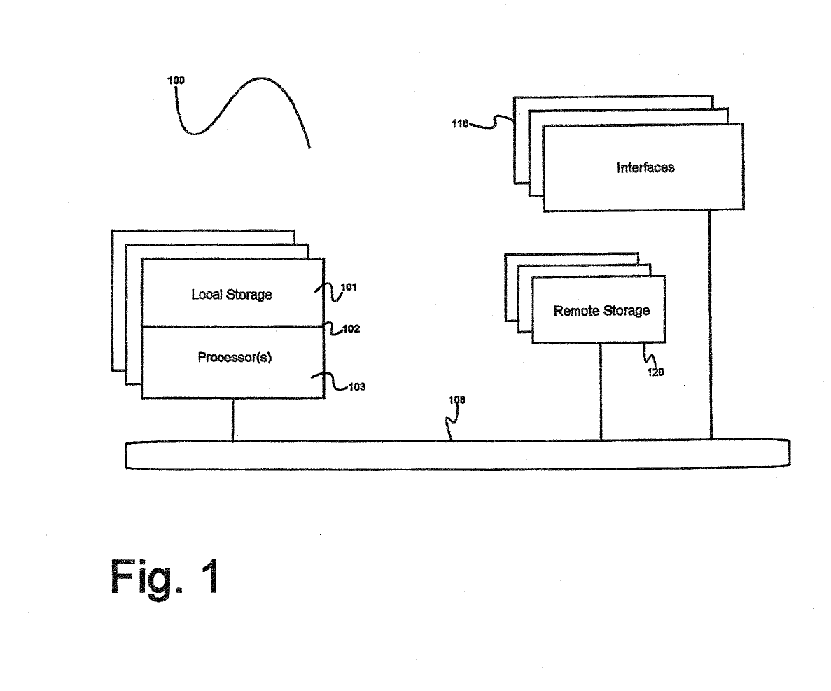

FIG. 1 shows a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software- or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more busses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the different types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, different types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

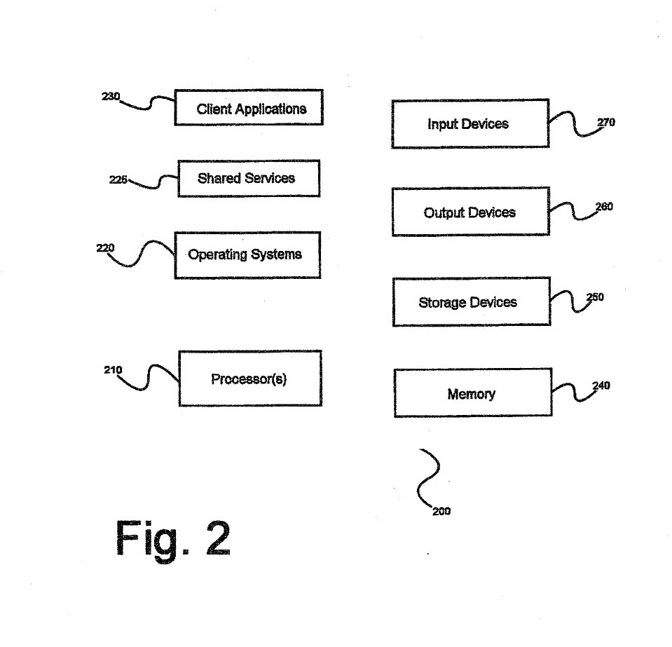

In some embodiments, systems according to the present invention may be implemented on a standalone computing system. FIG. 2 shows a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may carry out computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

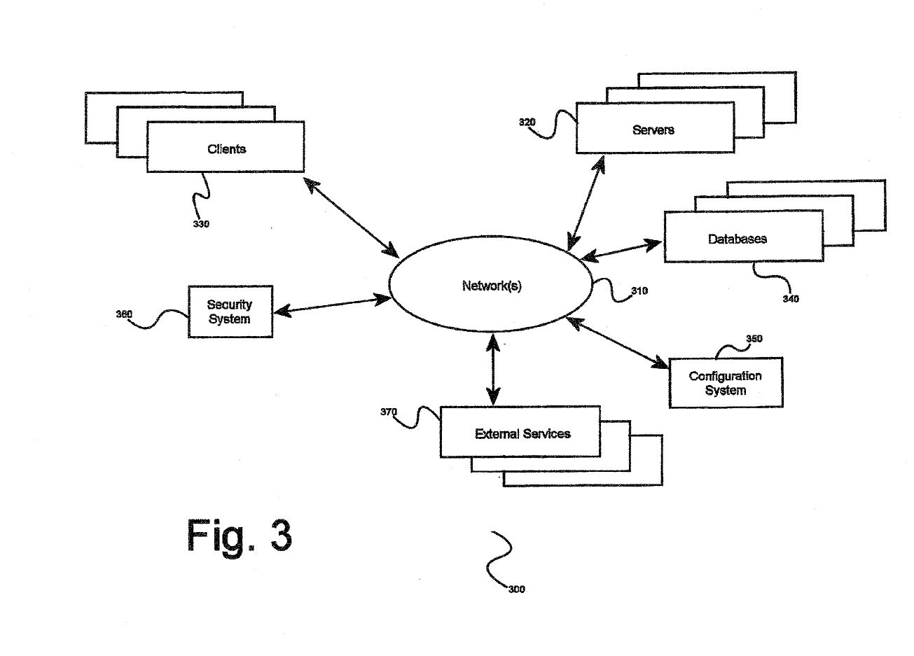

In some embodiments, systems of the present invention may be implemented on a distributed computing network, such as one having any number of clients and/or servers. FIG. 3 shows a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as WiFi, Wimax, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprise's or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google BigTable, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate, unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

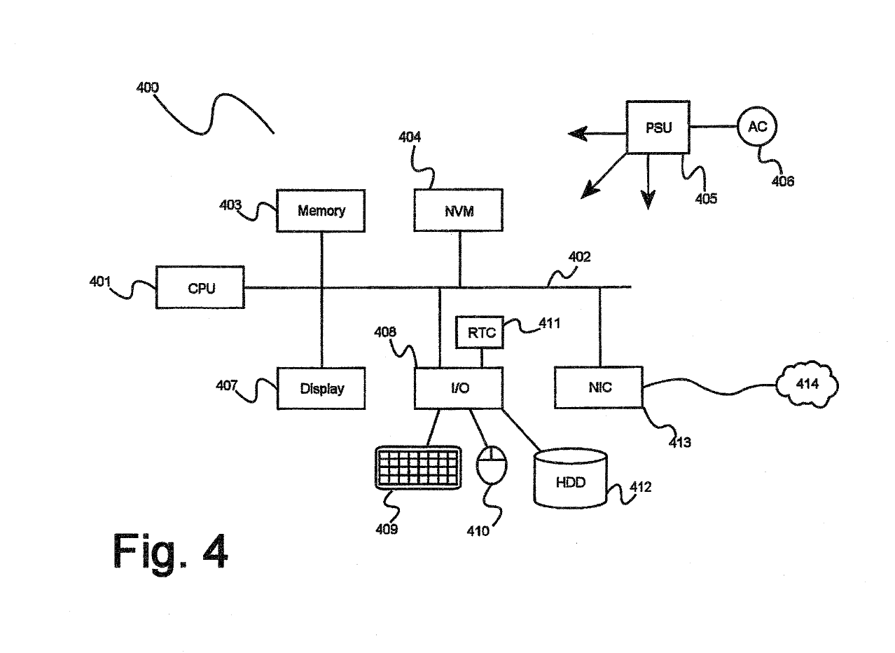

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

### Conceptual Architecture

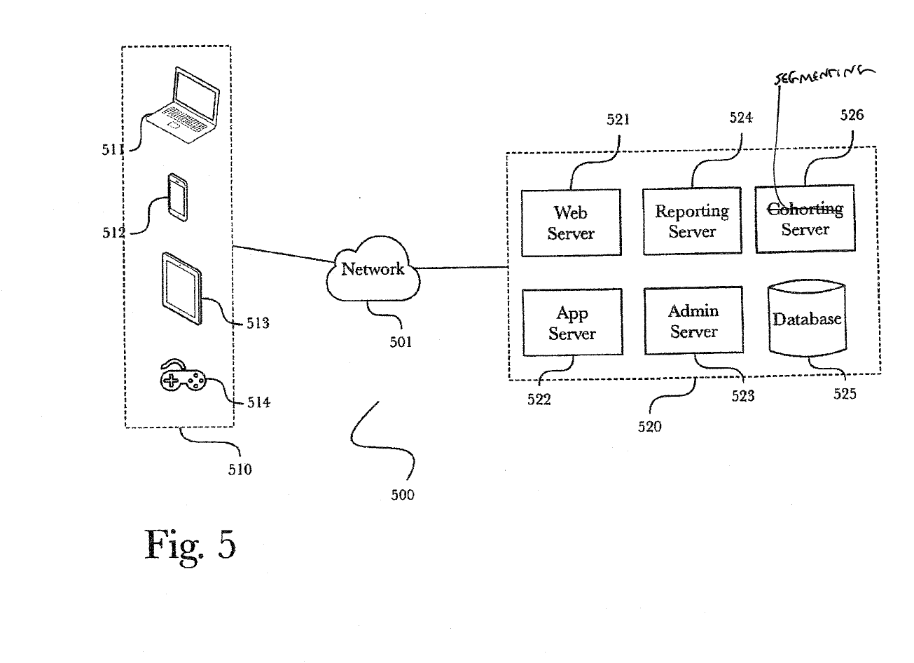

FIG. 5 is a block diagram illustrating an exemplary system architecture 500 for advertising optimization according to one embodiment of the invention. As illustrated, various traditional components of a computing network may be interconnected and in communication via the Internet 501 or a similar data communications network. It should be appreciated by one having ordinary skill in the art, that such an arrangement is exemplary and a variety of connection and communication means exist which may be utilized according to the invention, and it should be further appreciated that various combinations of connections and communication means may be utilized simultaneously or interchangeably according to the invention.

As illustrated, a plurality of users 510 may interact with an advertising optimization system 520 across a network 501 via a variety of hardware or software means common in the art, several examples of which are illustrated. It should be appreciated that such means as illustrated and described below are exemplary, and any of a variety of additional or alternate means may be utilized according to the invention. Hardware means may include (but are not limited to) electronic devices capable of communication over a network 501, such as a personal computer 511 (such as a laptop or desktop computer), mobile smartphone 512, a tablet computing device 513, or a video gaming console 514 (or other such dedicated gaming hardware, for example a handheld gaming device or an integrated home PC designed or utilized for gaming purposes, such as an OUYA™ or STEAM MACHINE™ device). As appropriate and according to the specific nature of a device being utilized, users 510 may interact using a variety of software means (not illustrated), such as a web browser accessing a webpage or other internet-enabled software (as may be appropriate when using a personal computer 511), or a mobile application (as may be appropriate when using a mobile smartphone 512 or tablet computing device 513). It should be appreciated that, as with physical devices described above, such means as described are exemplary and a variety of additional or alternate means may be utilized according to the invention. It should be further appreciated that such devices and means may communicate via multiple networks 501, either simultaneously (such as multi-band or MIMO configurations for wireless data communication) or interchangeably (such as a mobile smartphone with multiple radios for communication across a variety of protocols or frequencies).

As further illustrated, users 510 may communicate via a network 501 such as the Internet or other appropriate communication network, for such purposes as interaction with an advertising optimization system 520, various components of which may be similarly connected to a network 501 for communication, and which may also be interconnected within system 520 for communication with other components. Such components may include (but are not limited to) a web server 521 that may operate web-accessible content such as webpages or interfaces for viewing by users and also may receive web interactions from users (such as an interactive administration interface for viewing reports or taking report-based actions, as described below), an application server 522 that may operate various software elements for interaction such as via web-enabled means operated by web server 521 (such as an interactive reporting application, as described below and such as might be interactive via an interface presented by a web server 521 as described above), a database 523 or similar data storage component that may store data from other components as well as provide such stored data for interaction (such as for viewing or modifying existing or historical reporting data, or storing segment information such as definitions as described below), a reporting server 524 that may create or manage electronic reports, and an administration server 525 that may provide administration functions for user interaction (such as controlling or managing other components or features of system 520). It should be appreciated that internal components of a system 520 such as a reporting server 524 or administration server 525 may be directly accessible for user interaction (such as when a server operates its own interaction interface, as is common in the art with other computer applications) or indirectly via an interface or application operated by another component such as a web server 521 or app server 522, either simultaneously or interchangeably as appropriate according to the invention. For example, it is common in the art for a single software component such as an administration application stored and operating on a computing device such as an administration server 525 to be accessible via multiple means according to a user's preference or the nature of the desired interaction. For example, an integrated interface may be provided by an administration server 525 for basic interaction such as viewing the operational status of the server, while more complex interaction may be provided by a separate interface operated by a web server 521, allowing users a choice of interaction means.

As illustrated, a segmenting server 526 may be utilized for such purposes as to process, manage, and otherwise control segment definitions. For example, user account management for a game-based arrangement might be handled by a segmenting server 526, such as to define attributes of user accounts (groups of which may be considered segments according to the invention), metrics by which segments are measured, scored, or reported, or any other such segment-related functions. Additionally, segmenting server 526 may receive input from other components such as an administration server 525 for such purposes as to modify behavior or to alter specific segments, for example when a user wishes to alter the status of a user account or change the way in which certain metrics are tracked or reported. In this manner, a segmenting server 526 can be appreciated to serve multiple internal functions that are accessible to other components as needed.

As illustrated, reporting server 524 may be connected to and in communication with other components such as app server 522 such as to provide functionality for interaction via software elements (as may be appropriate for mobile device applications, wherein a user might directly view or interact with generated reports), web server 521 such as to provide functionality for interaction via webpages or similar web-enabled means, or database 523 such as to store and retrieve reports or information relevant to reporting (such as configuration or other criteria for generation of reports). In this manner it can be appreciated that a function of reporting server 524 may be to provide functionality to other components that may operate specific means of interaction, while still optionally providing functionality directly to user applications or devices 510 (as described above), thereby enabling a variety of arrangements and means of interaction according to the invention.

Reporting server 524 may perform reporting functions as described above, such as generating and providing reports of segment definitions, behavior, or interactions, metrics-based reporting as described below, or other various reporting functions that may be appropriate according to a particular use case according to the invention. It should also be appreciated that the functions provided by reporting server 524 may operate independently of additional components, such as in an arrangement that simply produces reports for use in an external system not part of the invention. For example, a reporting service for yield optimization may produce reports and provide them to an external or third-party product or service for presentation to, consumption by, or interaction from a user, such as a software-as-a-service (SaaS) or cloud-based use case. It should therefore be appreciated that additional components such as database 523 or app server 522 may be utilized as needed in various configurations according to the invention, and the arrangement illustrated is exemplary and by no means the only possible arrangement and that alternate arrangements such as might incorporate more, fewer, or alternate components may be possible according to the invention.

As further illustrated, administration server 525 may be connected and in communication with other components in a manner similar to that described above for reporting server 524, such as being connected to app server 522 such as to provide functionality for direct interaction via software elements (such as, again, in a mobile device application wherein a user might perform functions directly via an application interface), web server 521 such as to provide functionality for interaction via webpages or similar web-enabled means, and database 523 such as to store and retrieve information relevant to administration functions or operations (such as, for example, a user's stored preferences or historical administration operations). In this manner it can be appreciated that a function of administration server 525 may be to provide functionality to other components that may operate specific means of interaction, while still optionally providing functionality directly to user applications or devices 510, thereby enabling a variety of arrangements and means of interaction according to the invention. It should be appreciated that, as described above with relation to a reporting server 524, an administration server 525 may operate independently of other components as appropriate, such as to provide administration functions to a user while utilizing external or third-party solutions for other functions described herein, such as report generation or web interaction. In this manner, an administration server 525 may operate in a SaaS or cloud-based manner according to the nature of a specific arrangement, and various alternate arrangements may be possible according to the invention.

Administration server 525 may contextualize or normalize metrics reported such as (for example) with per-capita, relative, or distribution measurements. Metrics in the art often are recorded as raw numerical data such as “minutes played” being reported in a single active electronic game session. When contextualized, this metric data may become, for example, “minutes played per day”, or additionally contextualized for a particular segment. Metrics reported might include a variety of relevant or desirable summary, demographic, revenue, spending, virtual currency, engagement, retention, gameplay, or churn metrics. Such metrics may be reported over time, facilitating use according to a variety of potential administrative actions such as those described above. Contextualized metrics may then be provided to reporting server 524 for use in reporting operations, such as to provide a user with detailed contextualized information on segments (for example, “this player has played x minutes per day” or “players who spend y per hour of gameplay are less likely to churn”, or other such contextualized metric-based information).

Administration server 525 may utilize open-source or other existing frameworks or elements such as for ease of integration with existing components that may already be in use (thereby lowering initial cost to a potential client, both in terms of monetary investment as well as infrastructure concerns). Administration may comprise such features as multi-tenancy and security models (user accounts, administrative access control), or the ability to view various read-only information such as user data (such as names, contact information, non-editable history, or other such information that may be identifiable with users), policy definitions, segment definitions, and optionally the ability to synchronize data (such as for backup, version control, or synchronicity between multiple copies of similar data), such as is common in the art with cloud-based synchronization or data storage solutions.

It should be appreciated by one having ordinary skill in the art that the specific nature of a reporting server 524 or administration server 525 may vary according to the invention, such as optionally incorporating or utilizing open-source or third-party elements as are common in the art. It should be further appreciated that the interconnected and accessible nature of components of the system 520 of the invention may be seen as “closing the loop” between reporting and administration, allowing users 510 to perform administration tasks from within a report or in parallel, as may be afforded by a unified application interface (as would be operated by an application server 522) and that as described, the nature and function of system 520 may be adaptable to a variety of hardware architectures such as including (but not limited to) mobile computing devices (such as tablet computing devices or smartphones) or traditional desktop or server computer workstations. It should be further appreciated that various components of system 520 need not be physically collocated—that is, the specific nature of their interconnections and means of communications may vary according to the invention, such as direct cable or wired connections as may be appropriate for components located in close physical proximity (such as servers or similar computer hardware operating within the same physical location) or via network-based connections as may be appropriate for components operating in separate physical locations, effecting a distributed architecture. It should be further appreciated that certain components as described above may operate in a standalone, SaaS, or cloud-based manner, and it is the functions provided by these components that is relevant to the invention as described and claimed herein, and various alternate or additional arrangements of components utilizing various alternative components in place of or in addition to those described may be possible according to the invention.

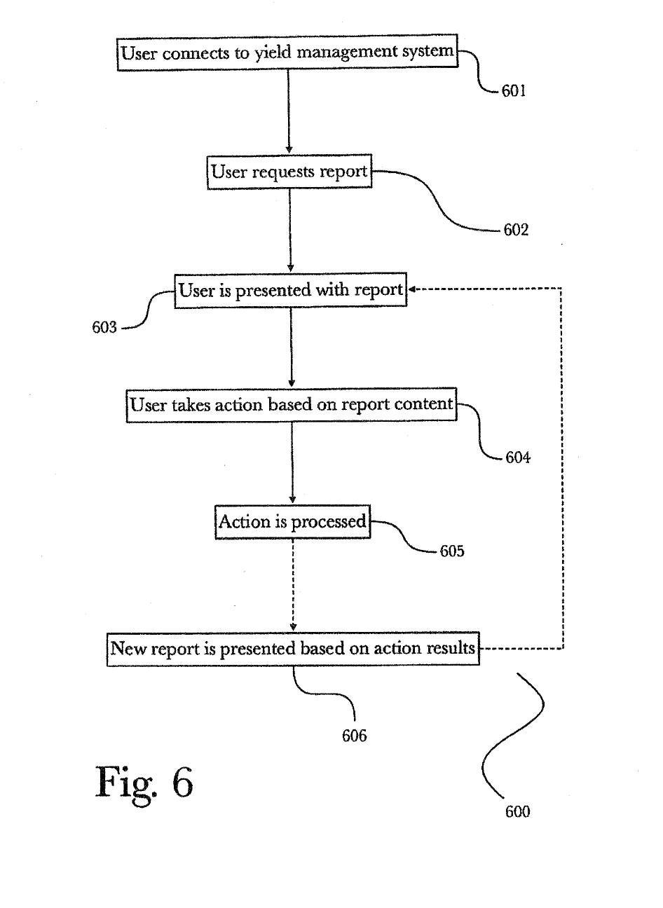

FIG. 6 is a method diagram illustrating an exemplary method 600 by which a user managing the advertising optimization service might interact with the system of the invention (as described above, referring to FIG. 5) such as to view a report and then take actions based upon information viewed, according to a preferred embodiment of the invention. As illustrated, the method described is from the perspective of a user interacting with the system of the invention for yield optimization, to illustrate the practical benefits offered as currently envisioned by the inventor.

In an initial step 601, a user may connect to an advertising optimization system via any of a variety of means according to their intended purpose, such as via a web interface or web-enabled application for viewing reports on a mobile computing device such as a smartphone (or other network-connected device). Such interaction means may be provided interchangeably or simultaneously by various components of a pricing optimization system as described above, such as a reporting server providing a reporting interface directly to a connected user, or a web server providing a web-based interface for users to access from their devices as needed, or other such arrangements.

In a next step 602, a user may request (such as by browsing through a menu and making a selection, or by submitting search query, or other such means of navigating information via a computing device) reporting information. Such information may be viewed “live”, or as it is being generated, such as when a user may wish to monitor current operations, or it may be retrieved as needed from a storage such as a database, to provide a user with prior or historical data for review. In a next step 603, the user may be presented with the reporting information, optionally including various interactive elements or means for taking actions form within the report, such as modifying rules or metrics that may be contained within or related to content of the report. In this manner, a user may be presented with options for both content consumption (reading the report) and actionable means relevant to the requested content, within a single unified interface and optionally without any explicit request or action (or even knowledge) on the part of the user—that is, actionable content may be presented automatically regardless of the user's request, such that a user may be proactively provided with options that may be useful to them (rather than leaving it to the user to decide what actions they may want to take, and then seeking out a tool or means for taking those actions).

In a next step 604, a user may take action based on the reported information, such as submitting messages to be sent to other individuals (for example, notifying a player that their account status in a game has been updated based on their reported behavior in the game), or modifying metrics that are reported (such as changing the basic content of the report to be more relevant to the user's interests). In a next step 605, the actions are processed (such as by an administration server, as described above), and a user may then request or be automatically provided with updated reporting information in a final step 606, facilitating a closed-loop operation model beginning again at a report viewing step 603. In this manner, it can be appreciated that the invention serves to provide users with a single unified means to view and modify their advertising optimization operations, and in doing so advertising optimization is made more accessible to users of varying skill or technical knowledge.

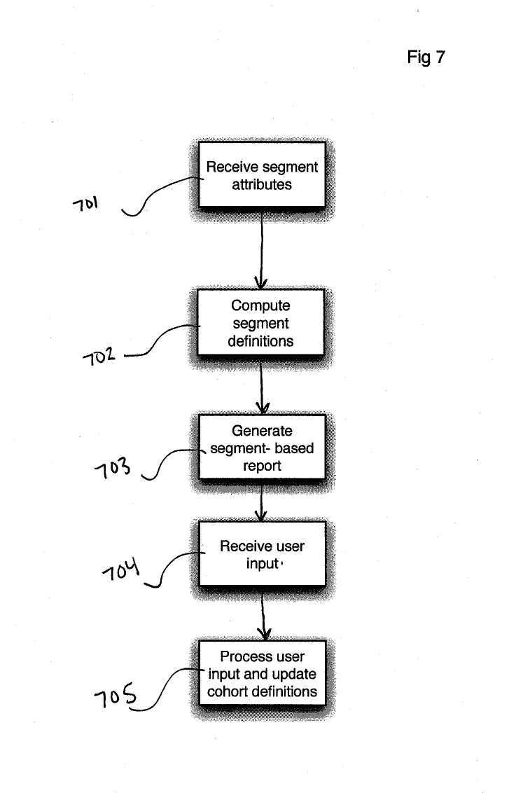

FIG. 7 is a method flow diagram, illustrating an exemplary method 700 for segment-based advertising optimization according to an embodiment of the invention (such as might utilize the system described above, referring to FIG. 5). In an initial step 701, a system for advertising optimization may receive general segment attribute information, such as from a preexisting database (such as when an advertising optimization system is being connected to an existing arrangement, such as a gaming network or a business management system) or from connected segments (such as users interacting with a system, for example players in a game or customers in a CRM system). Segment attributes might include, but are not limited to, usernames or identification information, account numbers, quantities of in-game currencies, character skills or other earned attributes, game items, or any other such information that may be considered relevant to a segment in particular or to operation of an automated advertising optimization system in general. In a next step 702, a segmenting server may generate segment definitions, such as by associating various attribute information with specific segments (for example, associating a user's in-game items and currency with their username or account number), such that a segment may now be considered to comprise a plurality of information both identifying the segment as well as defining a variety of associates attributes or qualities. In a next step 703, a reporting server may utilize these generated segment definitions to produce segment-based reports, such as by calculating metric-based statistics or other quantifiable reporting output based at least in part on the segment definitions. For example, based on a plurality of segment definitions that include usernames as well as metrics describing each segment's length of time participating in a game (for example), a report might indicate comparative playtimes for each segment, optionally contextualized as described above (referring to FIG. 5) to provide more relevant information such as “hours per day” for each segment. In this manner, it may be seen that by computing and utilizing segment definitions, specific information relevant to dynamic advertising optimization may be provided easily, and the use of segment definitions and a segmenting server for computation may also make the contextualization of metrics easier to provide for enhanced automated advertising optimization compared to solutions known in the art.

In a next step 704, a user (such as an advertising optimization analyst) may view a generated report, such as to review the current state of segments or the operation of a system in general. A user may then submit input in a next step 705, such as by making selections on an interactive report display, or by interacting with a web-based or other such interactive application for advertising optimization, for example to take action based on the reported information. In a final step 706, the user's input may then be processed such as by an administration server, applying any necessary changes and updating segment information as appropriate such that user input may be immediately utilized in future segment computation and reporting functions. In this manner, it may be appreciated that the method described herein offers a “closed-loop” means for a user to view and act upon advertising optimization reports, enabling direct management when appropriate and incorporating any such actions in order to keep segments and reports up to date and relevant. As described below, it is also possible to automate this process so that iterative advertising optimization can operate without requiring that a human operator or analyst manually adjust settings and parameters for each iteration.

In order to develop models that will differentiate users based on meaningful factors that are likely to predict their propensity to spend or other factors, it is necessary to test those factors against the behavior of users of a specific game or service. For each new product, new location or other optimization strategy and new customer population, there will be benefit to testing against a variety of factors or segments.

The process for arriving at the most meaningful differentiators is generally iterative. As previously practiced, this process has been slow, difficult and resource-intensive. In order to arrive at an optimal outcome quickly with minimal ongoing involvement of highly skilled (and thus expensive) human data scientists, a system as described herein can automatically progress from a point at which there is little or no knowledge about the most useful bases for segmenting users of a previously un-studied game, service or other electronically delivered product to a point at which useful segments have been identified and tested, and the game or service or other product has deployed dynamically optimized advertising based on those segments.

In one embodiment, the initial phase of the process is to apply a pre-set categorization schema to the user base of the game or service (and to the initial set of performance factors). Thus initially the users may be placed in segments based on characteristics that include but are not limited to:
Engagement
Intensity of engagement
Retention models
Knowledge regarding other games or applications loaded on the consumer's device
Join date
Time of day (for both when a user downloads the game or application, and when she uses it)
Day of week (for both when a user downloads the game or application, and when she uses it)
Purchase patterns (generally of goods offered within the game or application)
Country in which the user resides or in which the device has been registered with a carrier
Information about the device(s) the user is using including physical characteristics (for example, screen resolution), software characteristics (for example, which version of a particular operating system the device is using), and contextual characteristics (for example: list price, or age)

The relative importance of these factors will vary. For example, for a simple game with minimal learning curve and that takes only a few minutes to play, time of day/day of week are likely to be relatively unimportant; for complex games that take time to learn and complete, they are likely to be much more significant.

Different initial segmenting criteria may be used. While the system described herein will eventually arrive at optimized segments even if the initial segmenting criteria are not optimal, the closer the initial criteria are to optimal, the faster the subject invention may be able to begin maximizing results.

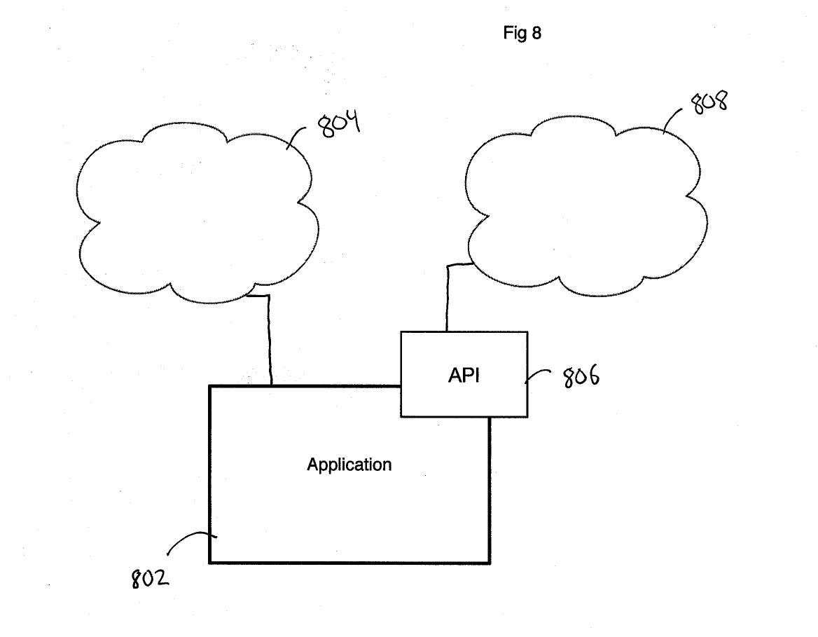

One means of deploying the subject invention involves integrating aspects of the invention into a gaming application deployed onto a mobile device. The advertising optimization service may offer a software development kit (SDK) to enable integration of the necessary functionality into a specific mobile gaming environment, as illustrated in FIG. 8. Similar techniques may be employed to employ the subject invention in mobile applications other than games.

Mobile game 802 resides on a mobile device. For numerous functions, game 802 communicates with a cloud-based server or servers 804 operated by the provider of game 802. Such functions may include connecting an individual player with other players in multi-participant games, storing attributes such as a player's accumulated experiences in the game to enable persistent attributes such as skill level, upgrades, etc.

In order to enable advertising optimization, SDK 806 may be integrated into game 802. SDK 806 enables at least two essential functions: it permits the SDK 806 to communicate bi-directionally with game 802, and it permits SDK 806 to communicate with one or more advertising optimization servers 808.

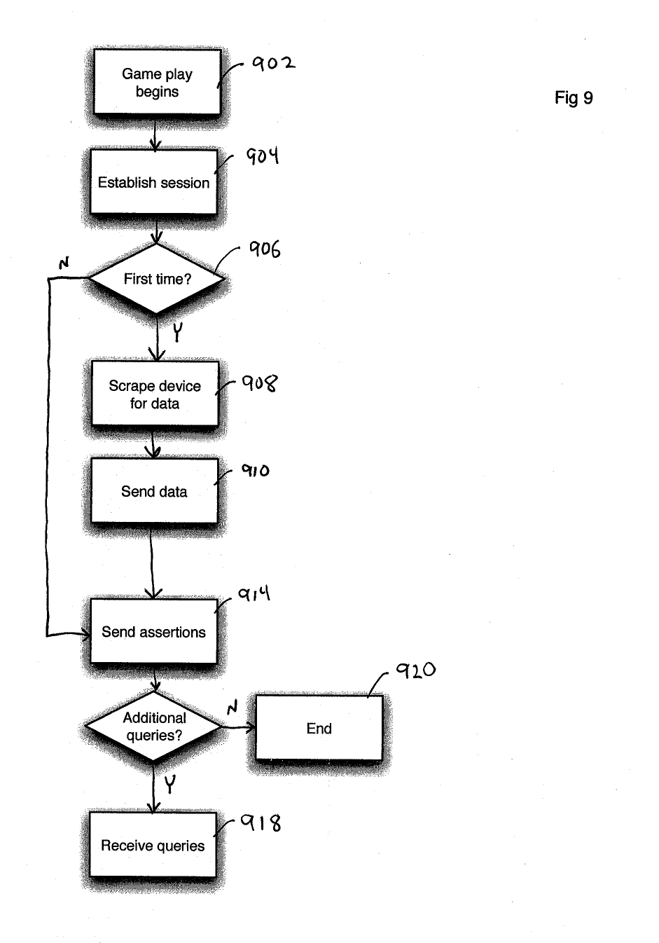

When a game provider has enabled the subject invention, and SDK 806 has been integrated into game 802, SDK 806 acts the first time the individual user begins to play the game, as shown in FIG. 9.

In step 902, the individual user begins playing a game in which the subject invention has been enabled. Code resident in the user's mobile or other device recognizes that game play has been initiated and opens a session with the advertising optimization server 808 in step 904. This session permits the exchange of messages and information between the end-user's device (which may be a mobile smartphone 512, a tablet computing device 513 or other connected device) and advertising optimization server as needed during and immediately after the conclusion of the game-playing session. Communication is established and maintained using techniques commonly understood in the field.

In step 906, advertising optimization server 808 determines whether the particular mobile or other device has previously been logged in to advertising optimization server 808. If it has not, then steps 908 through 912 are completed. In step 908, advertising optimization server 808 retrieves persistent data about that device. Such information may include factors such as the make and model of the device, the specific cellular network with which it communicates, the operating system and version it uses, the display characteristics (e.g., 720×1280 pixels, 4.8 inch diagonal) and many other characteristics. All current tablets, smart phones and personal computers report numerous attributes to requesting servers that connect via the Internet or cellular networks. Those attributes may include, but are not limited to hardware manufacturer (e.g., Samsung), model (e.g., Galaxy S4), and operating system (e.g., Android 4.4 KitKat). These attributes may be stored as part of the persistent record for each individual device used by a player of a game or application employing the invention. In step 910, the end-user device transmits the requested data to advertising optimization server 808. In step 914, the mobile device sends to advertising optimization server 808 various data points (“assertions”) associated with events and states relative to the playing of the game on the device. Such assertions may include items like:
This player just paid X in in-game currency to purchase good Y
This player just viewed the paywall for in-game currency
The “health” of this player within this game has recently decreased (health being an abstracted, non-game-specific quantification of the viability of a persona/role within the game environment)
This player has recently acquired Z experience points in this game or has advanced from level X to level X+1 (specific examples of the general proposition that progress and skill acquisition indicate higher investment in the game on the part of the player, which likely grants greater pricing power to the game provider)

Assertions can be tailored to permit learning relative to other game parameters as well. Considerable additional data may be acquired, including GPS data, internal accelerometer data, internal gyroscope data and other attributes. From these data points, the yield management service provider can infer potentially useful attributes such the list price of the device, the part of the world where it was sold, etc.

In step 916, the advertising optimization server 808 determines whether additional information from the device is useful at that time. If so, in step 918, additional queries are transmitted to the device, which are in turn answered with additional assertions in step 914, and so on. When there are no additional queries, (generally because the playing session has ended) the process stops in step 920.

The steps illustrated in FIG. 9 will be largely the same if the subject invention is enabled in a mobile application other than a game, thought the substance of the assertions and queries will likely be different. However, for virtually any application or transmittable media, information on the device will be available that the subject invention will be able to evaluate for factors that correlate with willingness to purchase additional goods, services or media or other factors that may be meaningful to the provider of the game or other service.

Next, the subject invention records the activities of the customers in terms of the segmenting criteria. The subject invention may, for example, record that hypothetical user 1157:
(i) is in Germany, and first played the game at 10:14 AM local time on Aug. 25, 2015, which was a Tuesday;
(ii) played one session of 24 minutes on the first day, two sessions totaling 37 minutes on day 2, not at all on day 3, and three sessions totaling 55 minutes on day on day 4;
(iii) continued playing the game for varying lengths of time for two more weeks; and
(iv) purchased no coins.

This process will be repeated for thousands (ideally, tens or hundreds of thousands) of users.

Once this information has been collected, the subject invention may analyze each of the segments for their predictive power—that is, to determine how well each segment, both individually and potentially in combination with other segments, predicts success (or failure) however it may be defined: often defined as long-term monetary value, but the subject invention is capable of application to a variety of metrics. These can include:
percentage of customers who purchase
average number of days between downloading or registering and purchase
average value of purchase
how long users continue to play/use the product

The subject invention can use the results of this analysis in multiple ways. As described in detail below, it can be used to adjust various parameters of the user experience. It is also possible to treat advertisement sources or the users obtained as a result of specific “more like this” requests as segments, and thus to determine not merely how many users have come from a given ad, but whether those users are profitable, or meet other criteria that are important or meaningful to the success of the game provider or seller of the service or product. If a specific seller of ad space refers many users, but very few of those users become paying customers, a game or application provider may decide that advertising with that seller is a poor allocation of resources, and choose to advertise elsewhere. If the users recruited as a result of a specific “more like this” request do not generate LTV that exceeds their acquisition costs or otherwise fail to meet expectations, that particular request can be retired, or may be reused but with a lower price per user, or otherwise altered. When the LTV or other measure of value can be measured and attributed to a specific advertisement, there is no longer a single price a vendor must be willing to pay for new users. A very wide range of users with widely varying propensities to spend can be profitable, but only at varying prices. The subject invention permits a buyer of such advertisements to determine the appropriate price to pay for essentially all such users.

In many cases, advertising is a major source of users and thus revenue for applications such as games. But the process of evaluating the value of a given advertising strategy has historically been very primitive. The subject invention provides buyers of such advertising with a powerful tool for optimizing the productivity of that advertising based upon a range of criteria, and to determine which criteria are most meaningful. It also provides means to automate that process, enabling this optimization to operate at sufficient scale and low enough cost to make it practical for advertisers to evaluate large numbers of advertising opportunities and strategies, even when the dollar value of an individual placement is relatively small.

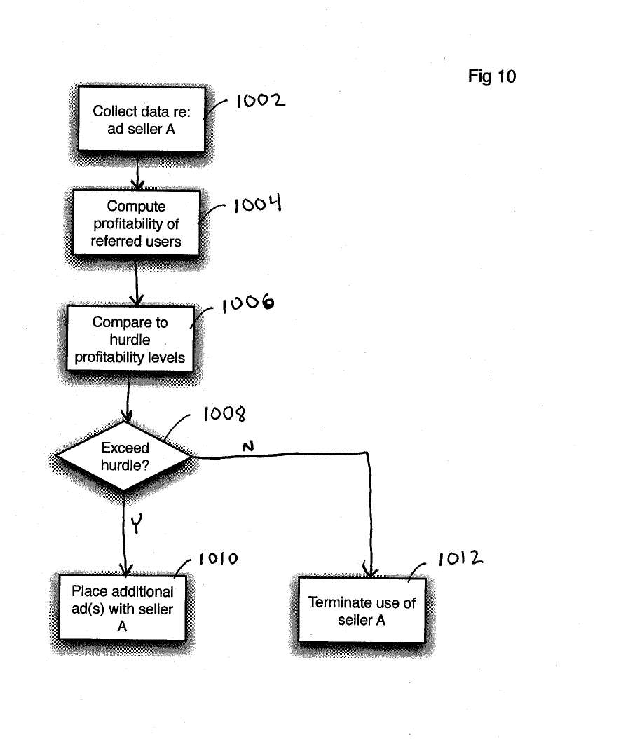

FIG. 10 is a flowchart for a process for determining the value of a specific advertising source and/or strategy, and using that information to adjust how an advertising budget is allocated. In step 1002, the subject invention collects relevant data regarding the performance of a specific advertisement. Such information may include but is not limited to the lifetime value (“LTV”) of the users acquired from that ad, ARPU (average revenue per user), ARPPU, (average revenue per paying user), etc. In step 1004, these attributes are used to compute the value to the game provider of that advertisement.

In step 1006, the results of that analysis are compared to one or more “hurdle” metrics that may be used to inform automated decision-making to maximize the value of advertising investments. Those hurdles can be static (e.g., “does the ad's revenue exceed its cost?) or dynamic (“does the 90-day revenue from this ad exceed the 90-day revenue for the last 3 evaluated ads?” In step 1008, the application determines whether the advertisement clears the hurdle. If it does, the invention initiates the process of placing additional ads such as the one evaluated in step 1010. If not, it terminates such purchases in step 1012.

Another step in the overall process is to apply a diagnostics framework to the previously generated data set. The diagnostics framework is intended to evaluate the initial segmenting categories against a variety of potentially useful economic criteria. Those criteria may include, but are not limited to:
% of users in a given segment who became paying users
% of paying users who bought more than once
% of users who purchased something on the first day of use
% of users who purchased something on or before the 2nd day of use
% of users who viewed a pay wall but did not purchase
average revenue per user (ARPU)
average revenue per paying user (ARPPU)

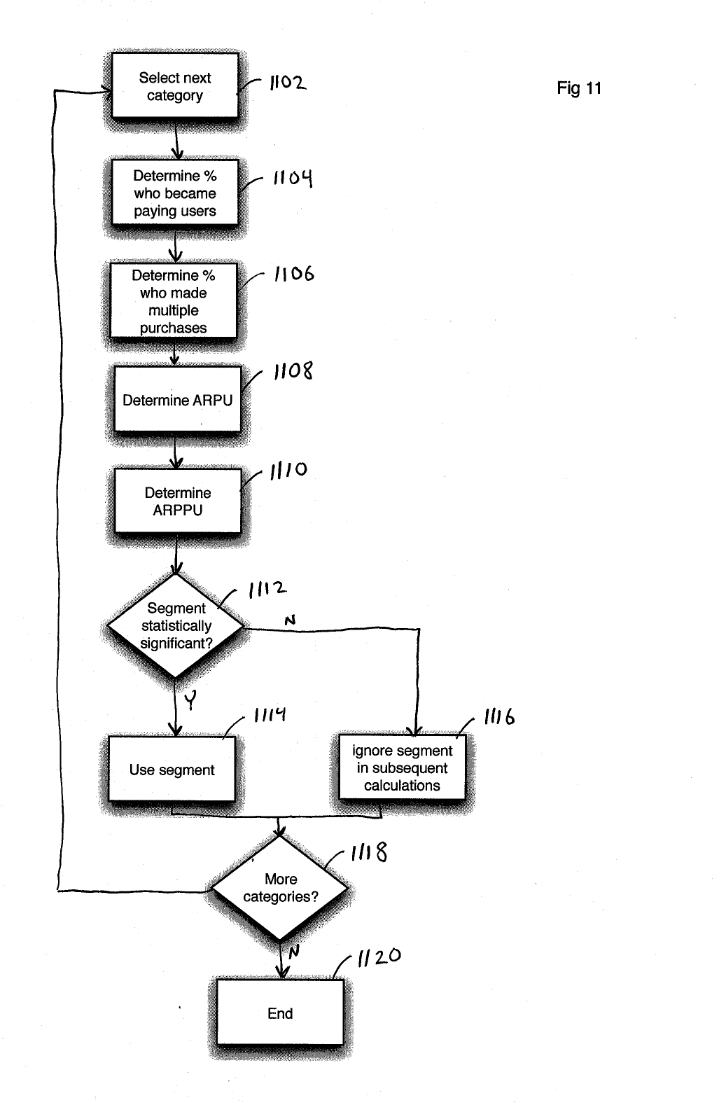

FIG. 11 is a flowchart illustrating a series of steps involved in one approach to applying tests to one of the previously discussed segments. In step 1102, the subject invention chooses a segment for evaluation. The subject invention may automate the process of sequentially evaluating multiple segments, as discussed below. In step 1104, it applies the first of a series of tests to that segment. In the case of step 1104, the test is to determine the percentage of members of that segment that became paying users of a specific game. In step 1106, the percentage of users who made multiple purchases is calculated. In step 1108 the average revenue per user (over a specific duration) is calculated for the segment. In step 1110 the average revenue per paying user is calculated for the segment. Additional or different tests may be applied.

Once the individual calculations for relevant metrics for a specific segment are complete, in step 1112 it is determined whether there is any statistical significance or other value associated with the segment—in other words, whether grouping users according to the specific segmenting criteria yields any useful insights. Even if the result is that the tests show that a given segment is an unusually unattractive audience for a given game, that knowledge can be extremely valuable, and can inform numerous critical decisions, including allocation of marketing budgets and product design. Significance could be shown if, for example, a segment is 40% more likely than the average user to become a paying user, or if average revenue for the segment is 60% lower than average.

If the segment shows value, then in step 1114 the segment is used in subsequent aspects of the invention as discussed below. If value is not shown, then in step 1116 it is ignored.

In step 1118 the invention determines whether there are additional segments to be evaluated. If so, the process repeats; if not, in step 1120 it ends.

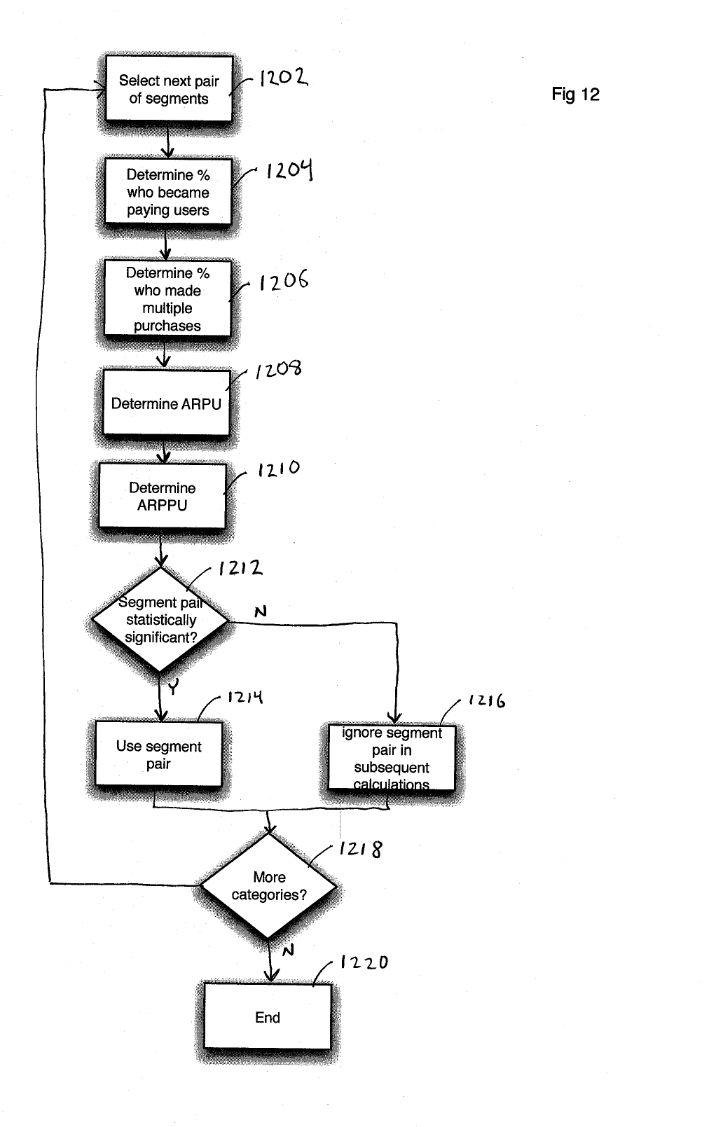

The subject invention may also apply the previously described economic tests to one or more combinations of the previously discussed individual segments. This step may find useful predictors that might not otherwise appear from analysis of single segments alone. For example, the Join Day of Week may not show great predictive power alone, which could also be the case for the Join Time of Day alone. But it may turn out that players who join on Friday afternoons are much more likely to become loyal players than those who join on Monday mornings. Thus Day of Week=Friday for first download alone may show no value; Time of Day=5-6 pm local time alone may show no value. But those two attributes together—i.e., the segment of users who first download the game between 5 and 6 pm on a Friday could turn out to be very meaningful. Thus it will be advantageous to evaluate not just individual segments for significance, but also combinations of segments. FIG. 12 is a flowchart illustrating the steps involved in applying one of these tests to two of the previously discussed segments. Similar processes may be applied to groupings of more than two segmenting criteria.

In step 1202, the subject invention chooses a segment combination for evaluation. In step 1204, it applies the first of a series of tests to that combination. In the case of step 1204, it is to determine the percentage of members of that combined segment that became paying users of the game. In step 1206, the percentage of users in that combined segment who made multiple purchases is calculated. In step 1208 the average revenue per user (over a specific duration) is calculated for the combined segment. In step 1210 the average revenue per paying user is calculated for the combined segment. Additional or different tests may be applied.

Once the individual calculations for relevant metrics for a specific combination are complete, in step 1212 it is determined whether there is any statistical significance or other value associated with the combination—in other words, whether grouping users according to the specific combination of segmenting criteria yields any useful insights.

If the combination of segments delivers meaningful differentiation, then in step 1214 the segment combination is used in subsequent aspects of the invention as discussed below. If no value is shown, then in step 1216 the combination is ignored.

In step 1218 the invention determines whether there are additional segment combinations to be evaluated. If so, the process repeats; if not, in step 1220 it ends.

The analysis as performed in the previous two steps will likely reveal one or more of several important potential results. For example, the analysis could reveal that 45% of users in the US who reach the paywall go on to complete a purchase of gold coins, while only 2% of users in India do so. It could reveal that the ARPPU is 70% higher for users who made their first purchase on the first day of use than for users who did not make their first purchase until at least five days after the first day of use. Or it may reveal that high intensity users who download the game on a Monday have significantly higher ARPU than users who download it on other days of the week. Each of these insights could drive specific adaptations to the advertising and/or marketing strategies applied to the specific product being optimized using the subject invention. So for example, if an unusually small percentage of users in Thailand make a purchase after reaching the paywall, the game may choose not to pay for users in Thailand. Or if players who make a purchase within 48 hours of the first day of use show a 300% higher lifetime value than players who do not purchase until later, and if players using the latest version of the iPhone and iOS operating system are 50% more likely than others to make a purchase within 48 hours of the first day of use, the game can structure its bid for advertisements for new users so that it only pays for users who have that combination of device and operating system.

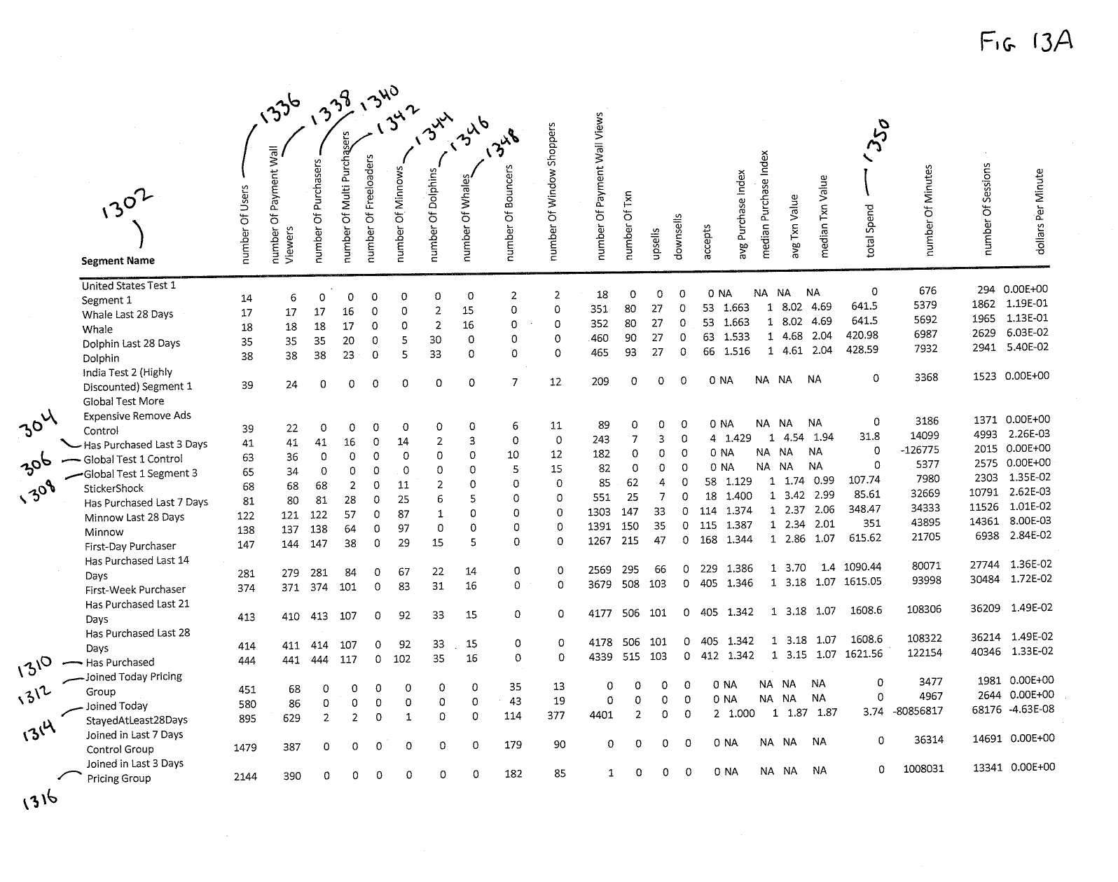

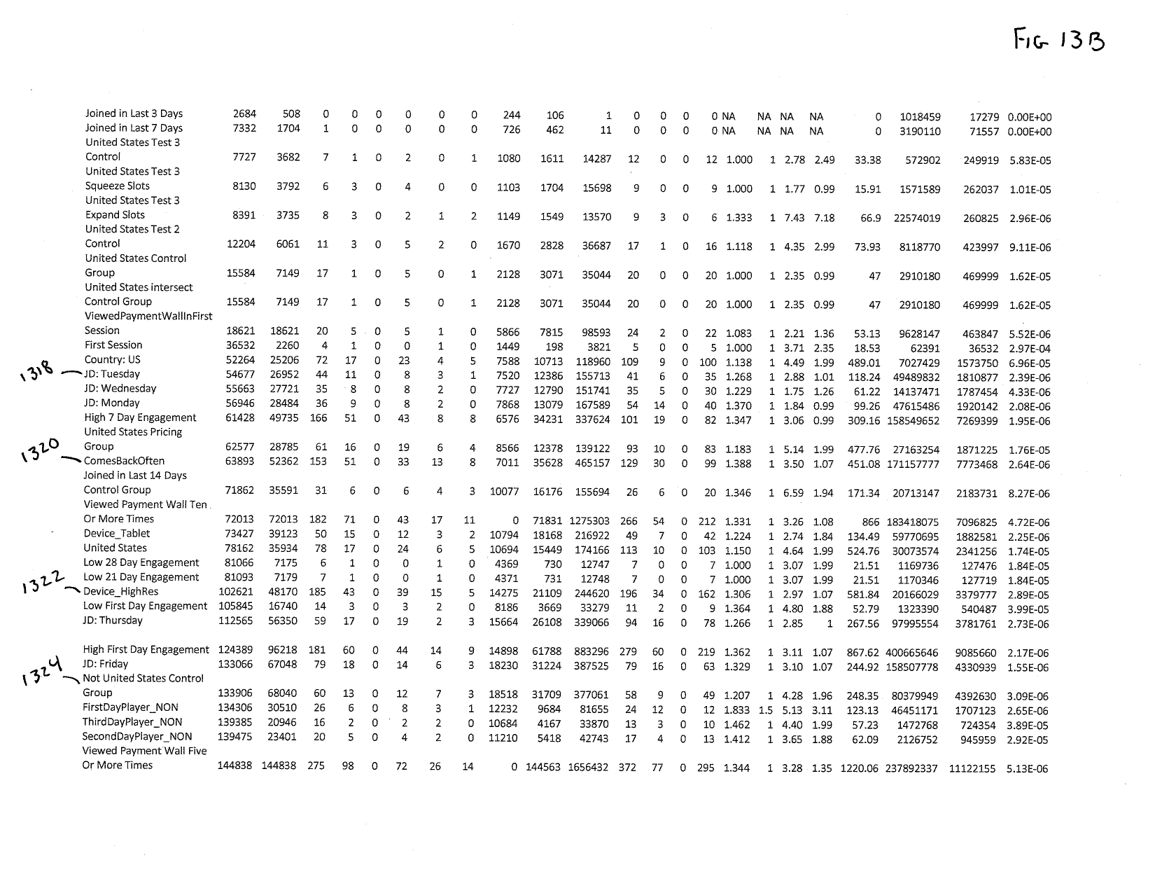

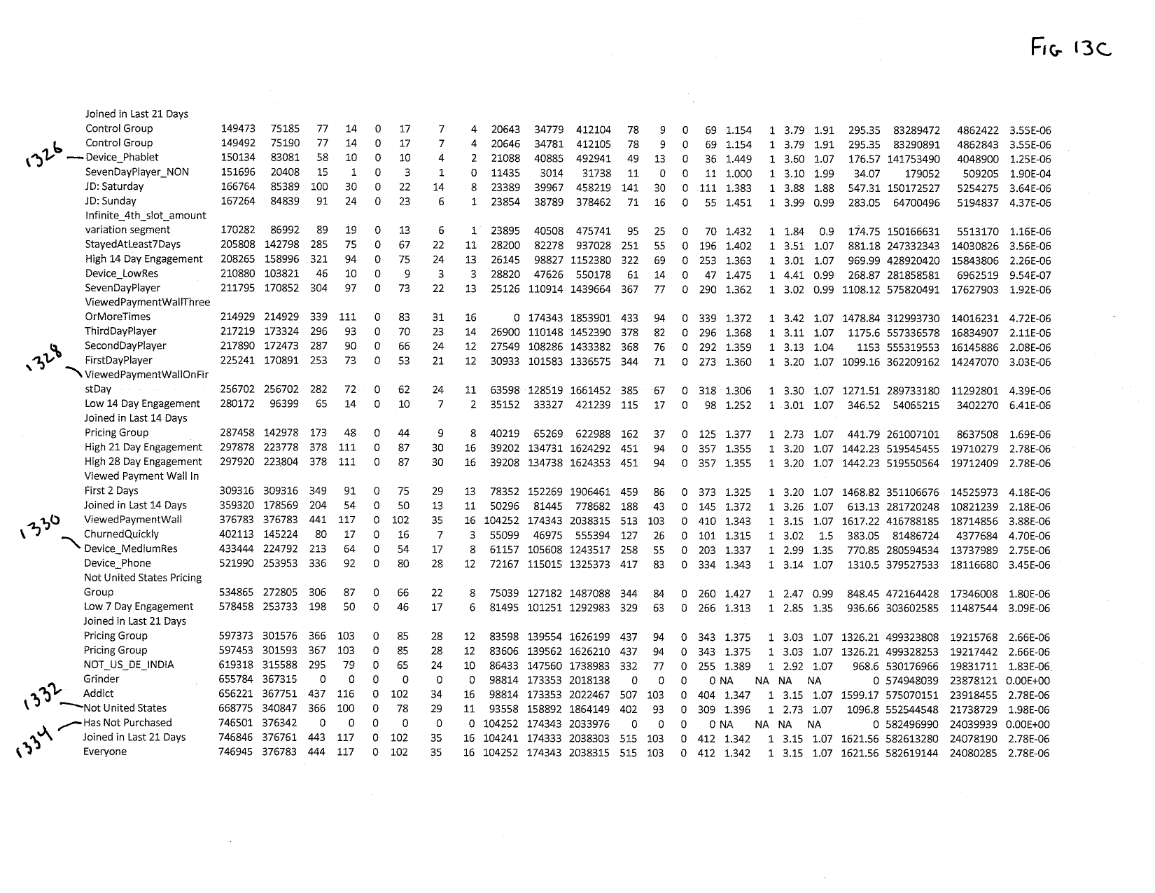

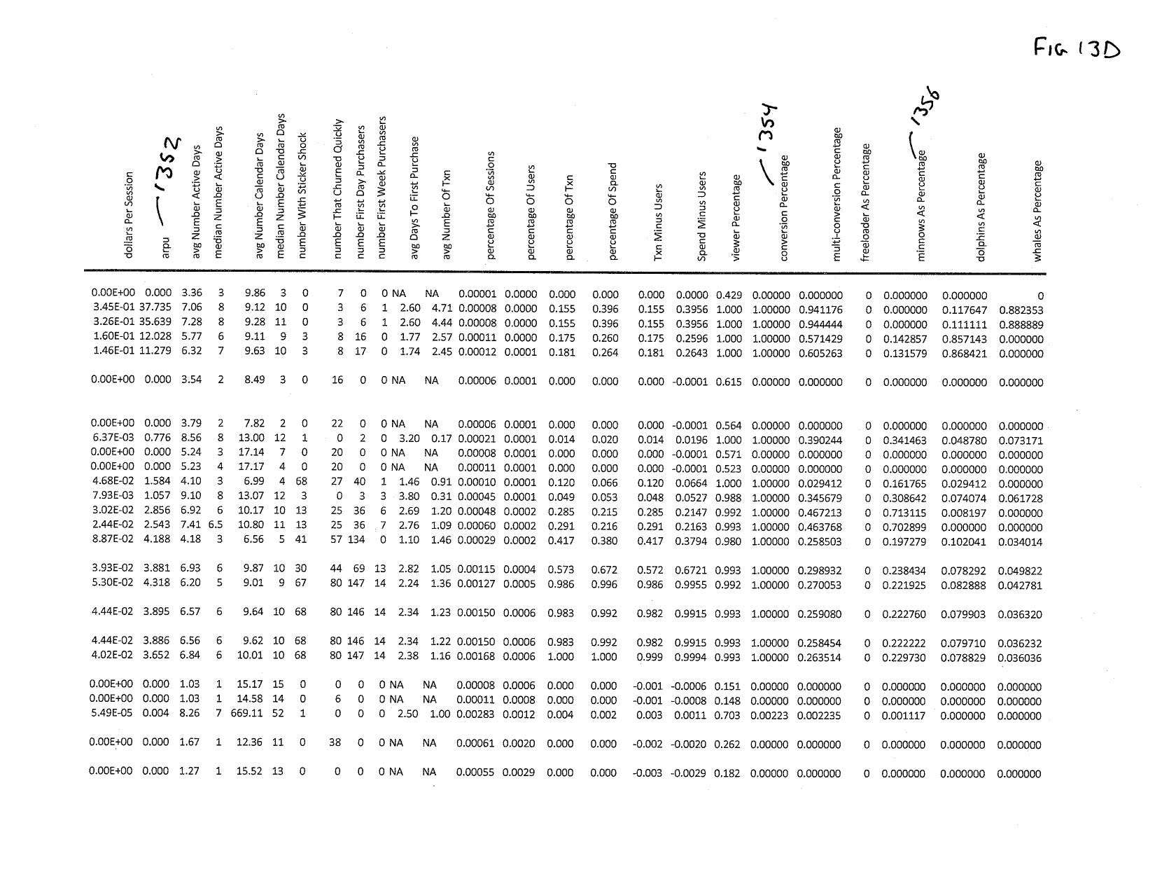

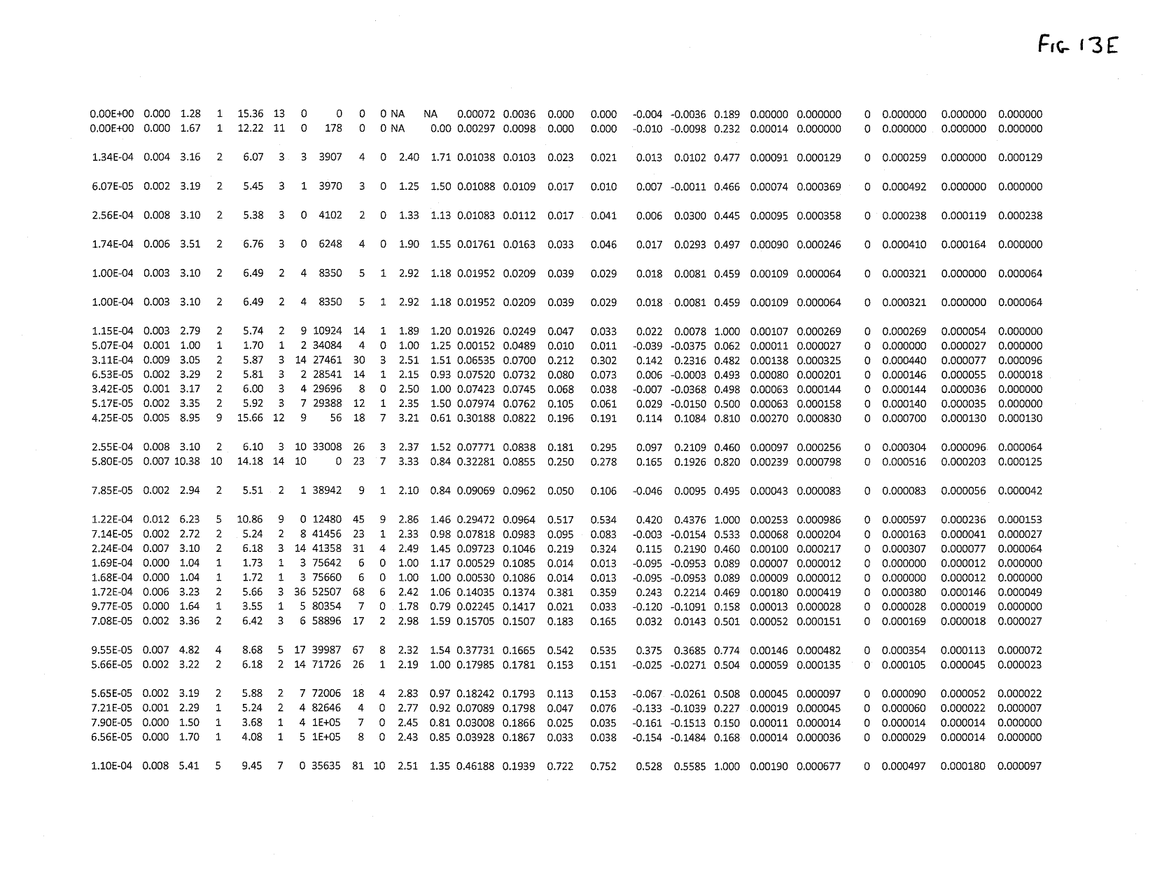

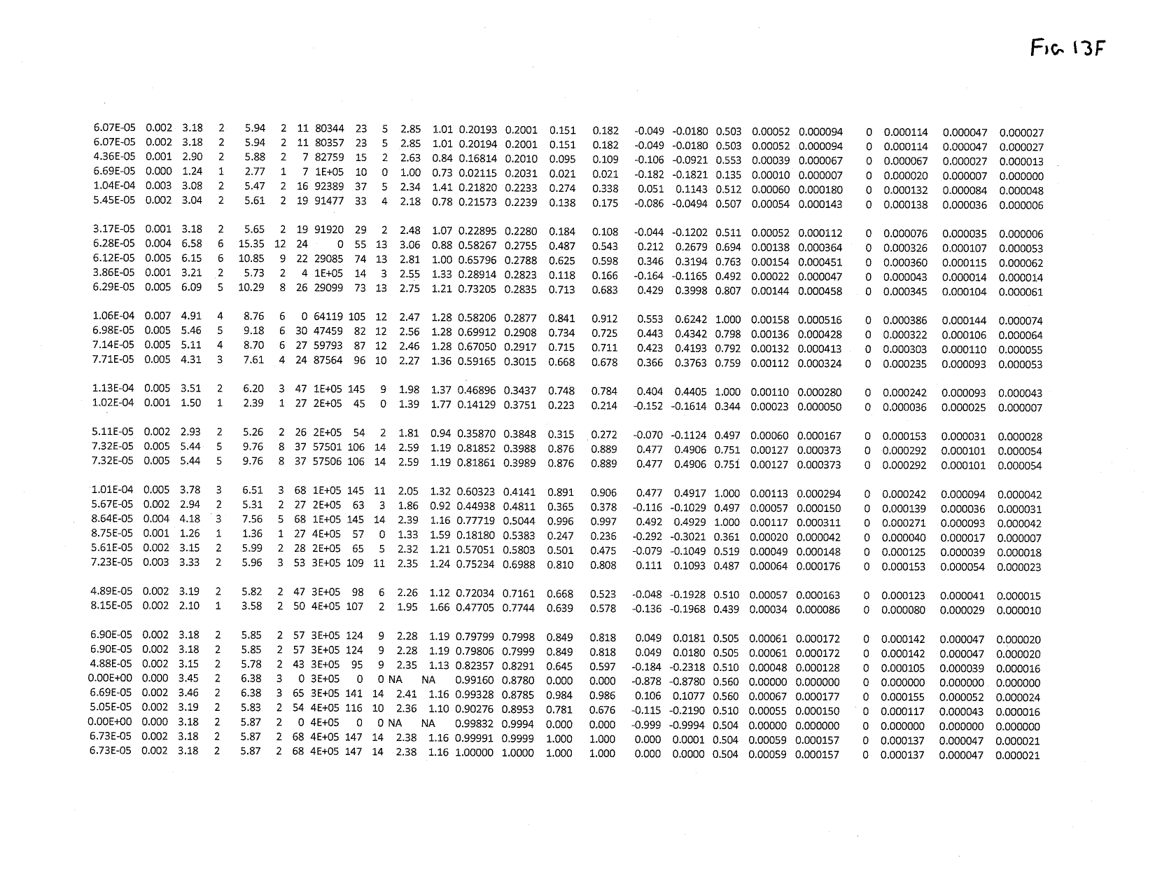

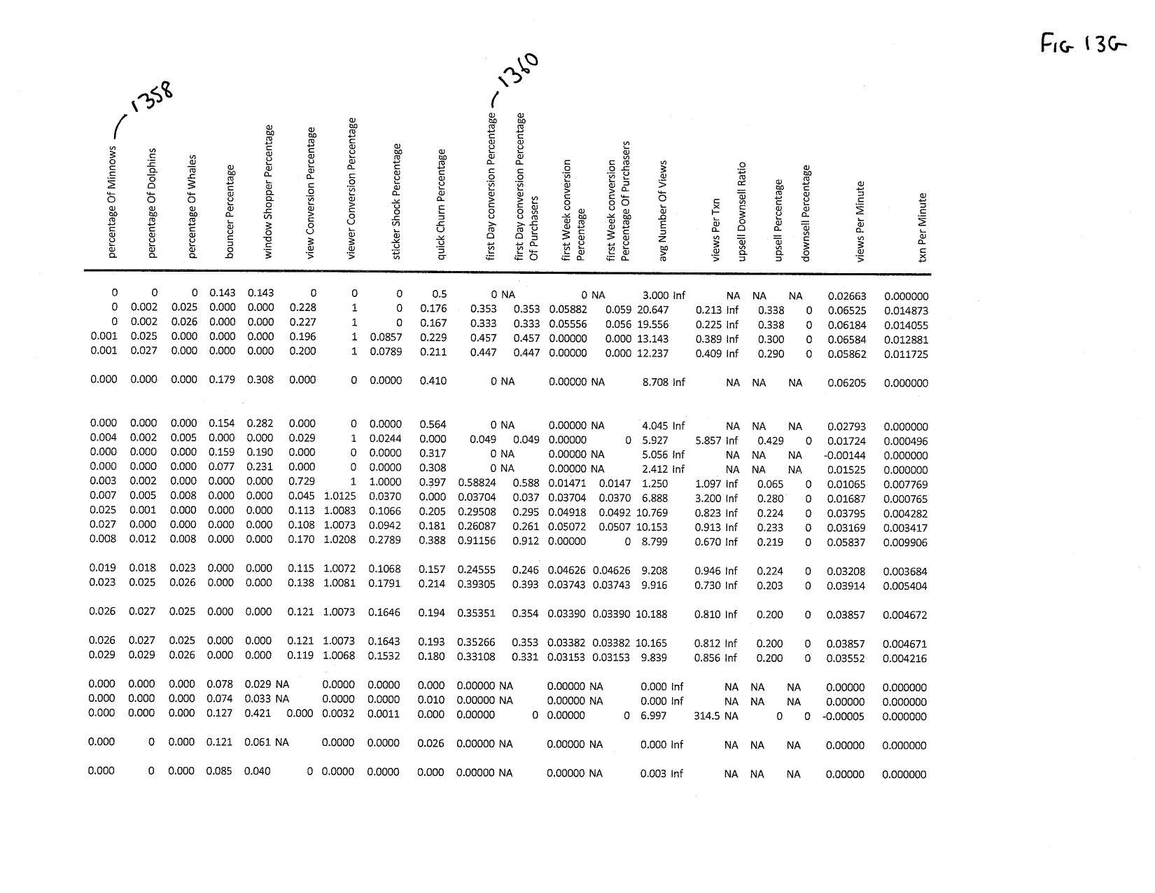

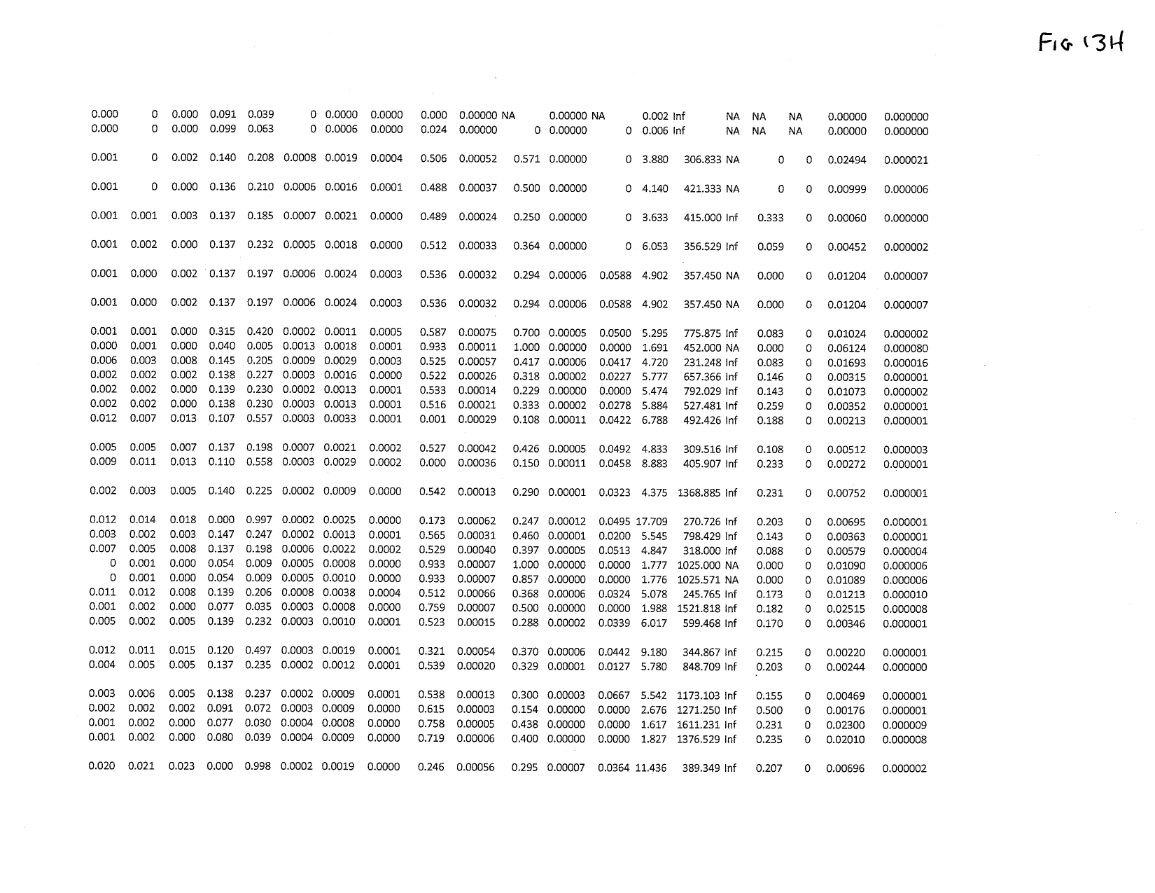

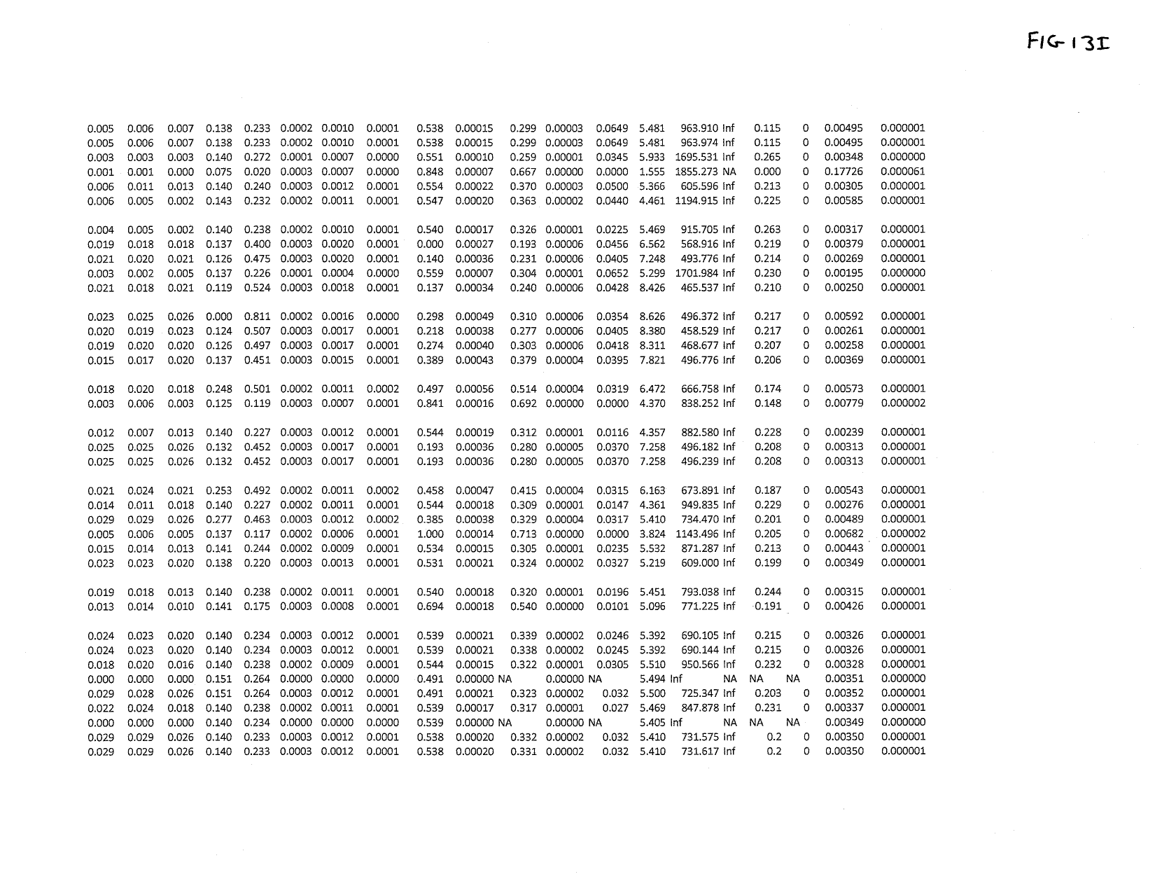

Of particular value is the specific analysis that compares, for various segments, the percentage (relative to all players/users) of time playing the game or using the service to the percentage (again, relative to the total) of purchase transactions for the specific type of transaction being evaluated and optimized. Such a comparison could, in the hypothetical case discussed above, yield a table as shown in FIG. 13, which presents a subset of the kinds of data and categories that may be used by the subject invention to discover and implement segmentation strategies.

Potentially useful segments are listed in the first column 1302; various potential attributes of those segments are listed in the remaining columns. Thus segments analyzed include users who have purchased in-application goods in the last 3 days in row 1304; all users who have ever purchased in-application goods are in 1310; all user who downloaded the game on the day the report was run are in row 1314; all users who downloaded the game on a Tuesday are in row 1318; all users who frequently play the game are in row 1320; users who play the game on a device with a high-resolution screen are in row 1322; all users who play the game on devices that are very large mobile phones or small tablets (known as “phablets”) are in row 1326; players who visited the paywall for in-app purchases on the same day they downloaded the game are in row 1328; players who downloaded the game to medium-resolution devices are in row 1330; all users outside the US are in row 1332; and all users who have not yet purchased anything are in row 1334. The subject invention may be used to simultaneously evaluate hundreds or thousands of such segments, and a single user may of course be evaluated in multiple rows.

Additional columns in FIG. 13 present by row various attributes of the segments listed in the first column. Thus column 1336 shows the total number of users in each row; column 1338 shows the number of users in each row who viewed the payment wall at least once; column 1340 shows the number of users in each row who have made at least one in-game purchase; column 1342 shows the number of users in each row who have made multiple purchases; column 1344 shows the number of users in each row who are categorized as “minnows” (i.e., those who occasionally make small purchases); column 1346 shows the number of users in each row who are “dolphins” (defined as player who spend more than minnows); column 1348 shows the number of users in each row who are “whales” (big spenders, and thus very desirable customers); column 1350 shows the total spend associated with the users in each row; column 1352 shows the average revenue per user in that row; column 1354 shows the percentage of users in each row who were converted from users to paying users; column 1356 shows minnows within a row as a percentage of all users, which column 1358 shows the percentage of all minnows represented by the minnows in each row; column 1360 shows the percentage of users in each row who converted to paying users on the first day of play.

The knowledge gained in each of the previous steps is used in the next step in the subject invention, which is to generate new segmenting strategies, which can be analyzed along with the initial segmenting strategies that prove useful, thereby enabling the game or service provider to optimize pricing and other aspects of the user experience.

When a consumer downloads an application such as a game to a mobile device, the application will generally inform the consumer that, in order to use the service or game, the consumer will have to give permission to the game or service provider to perform operations that may include accessing data stored on the device.

The process of generating additional segmenting strategies leverages the wealth of facts and attributes that can be gathered regarding users of games or other services that are played or used on mobile devices. These factors may include:
The make and model of the device (or devices) used to play the game or use the service (e.g., Apple iPhone 5, Samsung Galaxy 5, etc.)
The primary service provider with which the user has a service contract (e.g., Verizon, Sprint, etc.)
Whether the user viewed an advertisement for the game or service, and if so which one(s)
Information regarding other games or product/services that have been downloaded on to the device
Information regarding which other games or products/service are currently in random access memory on the device (suggesting that they have recently been used)
The location of the device, both generally (i.e., which country) and more specifically (GPS coordinates, stationary or moving, location relative to the nearest cell tower, etc.)

Analysis will reveal that some of the segments are better at predicting the desired outcome than others. For example, for a game that demands powerful graphics processing, it may be that the segment of users with the latest mobile devices are much more likely to become paying users of the game than user whose devices are more than two years old. A game that simulates farming in a highly stylized manner may find few paying users in a geographic area where a large percentage of users are actually farmers.

However, there is a fundamental difference in terms of value to a game or service provider between characteristics that can be identified early in the interaction with the game provider (or even prior to that interaction) and those that emerge gradually over the course of a user's interaction with that game or service. For example, if it is the case that immutable characteristics, such as key attributes of the device used (screen size, processor speed) or the country where the device is sold or registered with a carrier reliably predict whether a user will be of high or low long-term value as a customer, that knowledge is likely to be of greater value than a predictor that is only observable after collecting a month's worth of data after a user has downloaded the game or service/application, such as actually observed intensity of use. A game provider may bring intuition to these questions, but the subject invention brings the ability to automate the process of discovering and acting upon those relationships.

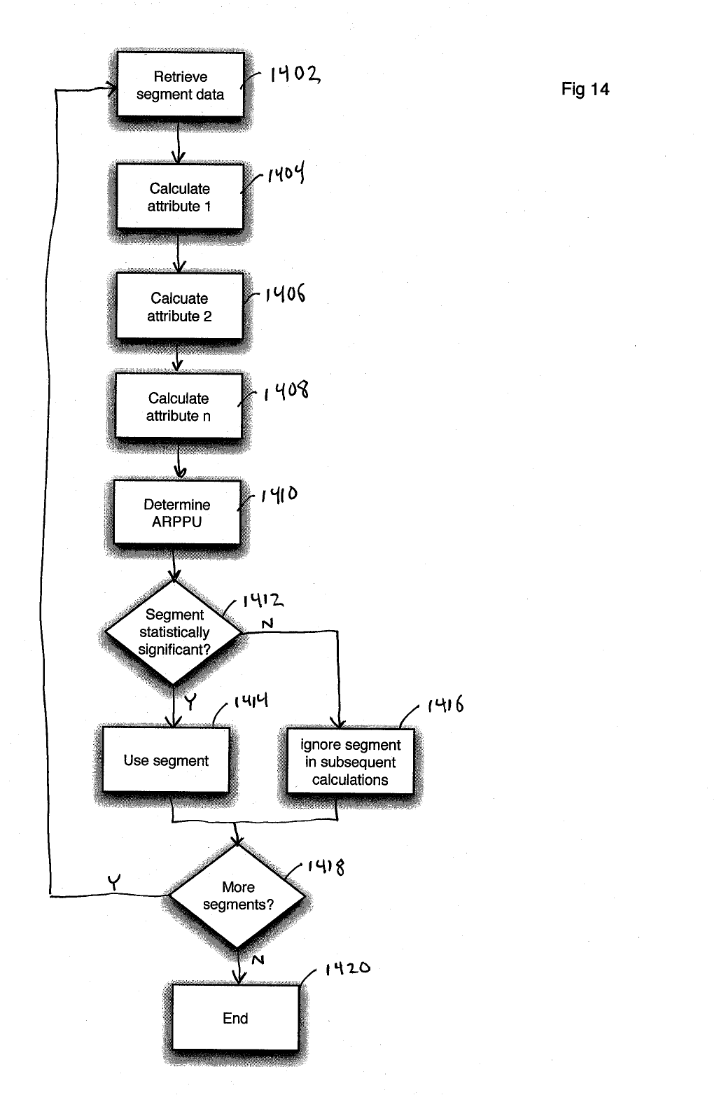

The subject invention can be used to evaluate whether each of these additional segmenting attributes is correlated with the desired outcome. A process for accomplishing this analysis is shown in FIG. 14.

In step 1402, the subject invention chooses a segment for evaluation. In step 1404, it applies the first of a series of tests to that segment. In the case of step 1404, it is to determine the percentage of members of that segment that became paying users of the game. In step 1406, the percentage of users who made multiple purchases is calculated. In step 1408 the average revenue per user (over a specific duration) is calculated for the segment. In step 1410 the average revenue per paying user is calculated for the segment. Additional or different tests may be applied.

Once the individual calculations for relevant metrics for a specific segment are complete, in step 1412 it is determined whether there is any statistical significance associated with the segment—in other words, whether grouping users according to the specific segmenting criteria yields any useful insights.

If the segment shows value in differentiating and predicting user behavior, then in step 1414 the segment is used in subsequent aspects of the invention as discussed below. If significance is not shown, then in step 1416 it is ignored.

In step 1418 the invention determines whether there are additional segments to be evaluated. If so, the process repeats; if not, in step 1420 it ends.

As discussed in FIG. 12, above, in addition to evaluating these segmenting factors individually, it is also possible and desirable to evaluate various combinations of these factors.

The subject invention can then combine the most useful segments from the original set of standard segmenting criteria with the most useful segmenting criteria from the extended set. For example the data may show that users who both downloaded and repeatedly play a given game on more than one up-to-date device, have at least five other similar games on their devices and live in certain zip codes in the United States are much more likely than the average user to make multiple purchases of in-game currency at the prices used in the default pay wall, whereas users who download the game to a single three-year old device and live in Spain are very unlikely to make even a single purchase regardless of how many other games they have downloaded.

One of the assumptions that the subject invention can effectively test is that the likelihood that a player sourced from advertisements on website A will make in-game purchases will be repeatably distinct from the likelihood that a player sourced from advertisements on website B will do so. Because the subject invention can successfully identify characteristics that are reasonably effective in predicting propensity to make such purchases, it can, as described in greater detail below, enable the game or other service to improve the performance of its advertising budget.

Because the subject invention can predict with reasonable accuracy that this hypothetical game is, for example, unlikely to generate revenue from customers with older mobile devices in Spain, at least at price levels that work for many U.S. customers, it can automatically adapt to these insights and attempt to increase revenue from that segment by increasing investment in advertising with ad sellers that tend to generate higher revenue, and reducing investment in advertising with ad sellers that tend to generate lower revenue. For example, players on a latest-generation device with a billing address in Grosse Pointe, Mich. (characteristics that have been shown to indicate a high likelihood of in-game purchases) may prove to be strong revenue generators, and thus ideal advertising targets, though that group represents a relatively narrow target. Through learning as described herein, the subject invention may determine that revenue will be increased if similar audiences are targeted—for example, other geographic regions where spending behavior has previously been shown to be similar.

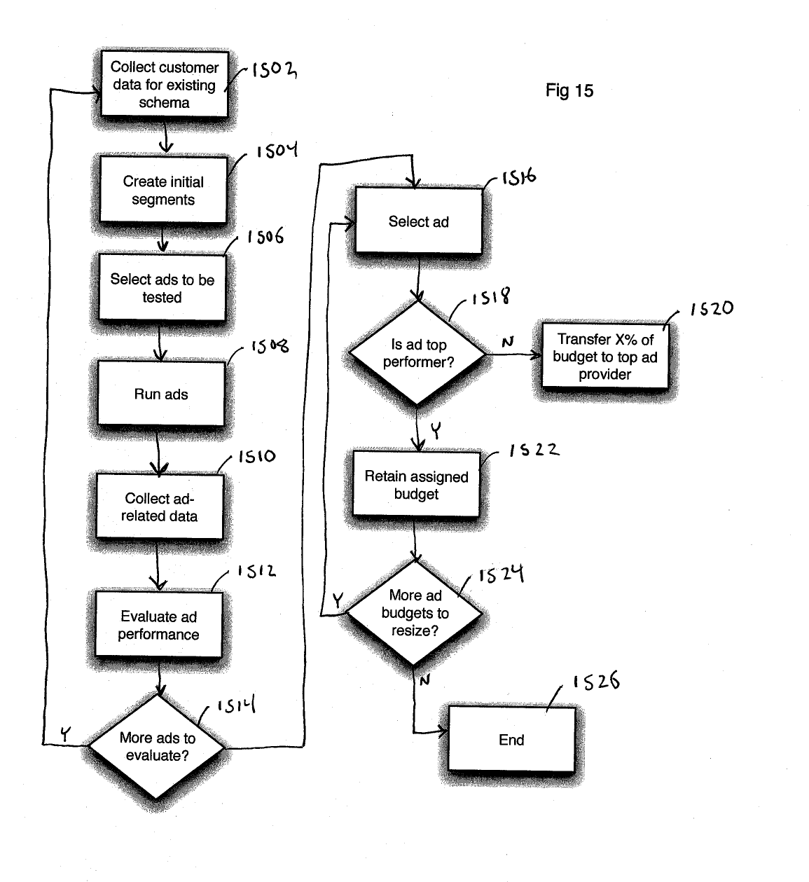

One method for employing the subject invention to quickly improve performance of an advertising campaign for a game, product or service already in use by customers is shown in FIG. 15. For purposes of this example, it may be assumed that the product for which an advertising campaign is to be optimized is a game for mobile devices. In step 1502 data is collected regarding the users of the game and their experiences in playing the game. As previously discussed, such data may include information about the device used, how often the user plays the game, etc. In step 1504, a segmenting schema is generated. Segmentation can be based on a variety of schemas. For some optimization processes it will make sense to create a control segment and multiple test segments, and to assign users randomly. In some cases all users will be included in the protocol; in other cases the protocol will be limited to a subset of users.

In step 1506, the list of advertisements/locations to be tested is generated. This list will consist of at least the specific content of the ads, the locations where they will be displayed, and the budget allocated to each such ad In order to maximize the chances of generating valid results, it will often be advisable to include a reprise of a previous successful advertising campaign as a control as well as multiple test scenarios. In step 1508, the selected advertisements are placed. If there is a high value placed on minimizing the chances that process will, even in its early stages, generate results that are inferior to those generated prior to implementation of this process, it may be advisable to initially assign a large percentage of the advertising budget to the control group, and only begin increasing the spending on one of the newly created test segments after it has been established that that regime performs better than the control regime.

In step 1510, data is collected regarding the performance of all of the ads. In step 1512 the performance of a given ad is evaluated. Thus it may be appropriate to determine the percentage of users sourced from that ad who have made purchases, the average and/or mean purchase amount, the average and/or mean number of purchase transactions, etc. for the users acquired from each of the advertisements. In step 1514 it is determined whether there are additional ads to be evaluated; if so, step 1512 is repeated; if not the invention proceeds to step 1516.

In step 1516 the performance of each advertisement in the first iteration of the test is selected in turn for ranking against the chosen metrics. In step 1518 it is determined whether the advertisement is the best performing among the tested advertisements. If the advertisement is not the top performer, then in step 1520 some or all of the budget previously allocated to that form of advertisement is reassigned to the top performing form of advertisement for the next iteration of the process. If the form of advertisement being evaluated is the top performer, then in step 1522 the budget allocated to that form of advertisement in the first iteration of test remains allocated to that form of advertisement for the next iteration. In step 1524 it is determined whether there are additional tested advertisements to be resized; if so, steps 1516-1522 are repeated; of not, the process ends 1526.

It should also be noted that the subject invention may be used not only to identify and acquire the most desirable users of a game or service, but can also be used to identify the least desirable users and minimize the expenditures used to acquire them. In the game context, players who are heavy users but rarely or never spend money within the game are sometimes known as “grinders.” If a game permits some form of play at no cost, then there is nothing wrong with what those players choose to do. But large numbers of grinders can drive up the cost of providing a web service while providing no revenue. Thus it would be very helpful to a game provider to be able to adjust its marketing efforts so as to minimize the number of grinders attracted by its advertising. This can be accomplished by slightly altering the processes previously described. Thus the segmenting strategies described may be used in a “more like this” mode as previously described (that is, to identify high-value user attributes and employ knowledge of those attributes to select advertising strategies that are likely to bring more new users who share those attributes, and are thus more likely to behave and spend like those previous high-value users). But they can also be used to refine advertising strategies by employing a “not like this” analysis (that is, identify user attributes that likely identify low-value, and use that knowledge to select advertising strategies that are likely to reduce the number of new users who share those undesired attributes). (It should be noted that such a process does not prevent low value users from downloading and using the game; they simply minimize the money a provider spends deliberately attracting them.)

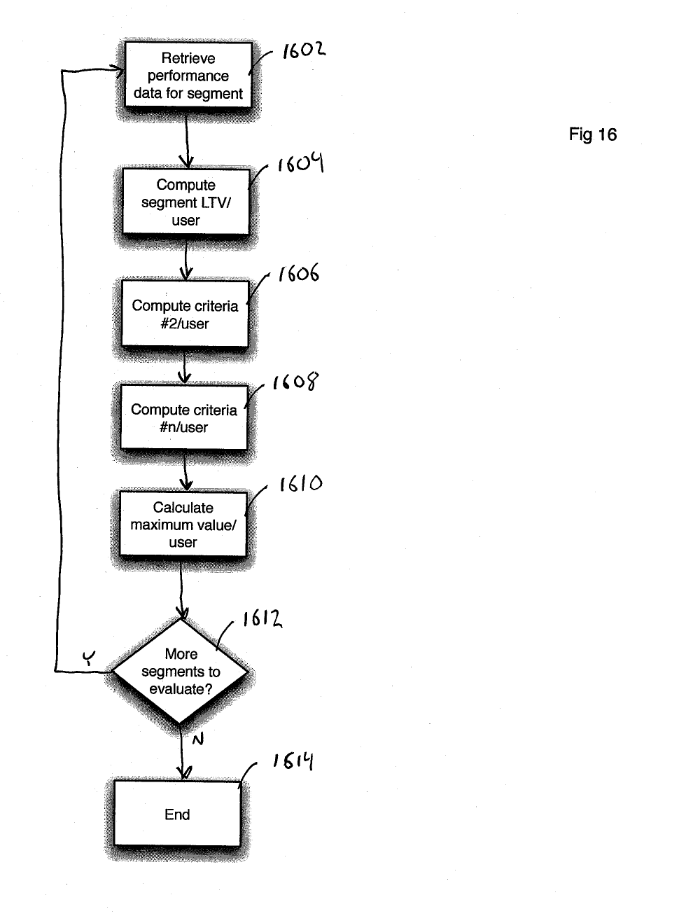

FIG. 16 shows a method according to the subject invention for discovering the highest price that a buyer should be willing to pay to acquire a user in a particular segment. In step 1602 the performance data for a given segment of users is retrieved. The segment in this case is likely to be the group of users obtained as a result of a single “more like this” advertising placement. Performance data may include some or all of the data previously discussed relating to the number, size and timing of purchases, as well as any available data about whether a given user may have referred additional users or otherwise contributed to the viral adoption of the product.

Next the performance data for the segment is evaluated. In step 1604 the long term value of the users in the segment is calculated. This value may be calculated based on a full data set if the segment evaluation takes place a sufficient length of time after the “more like this” transaction has been completed. However, the pattern recognition and other analytical processes described elsewhere in this document enable the subject invention to use predictive analytical techniques to estimate long term value for a given user well before most of the long term value of a customer has been realized. In step 1606 a second measure of value may be calculated. Potential additional measures may include the number (and LTV) of additional users who have installed the game or other application as a result of actions taken by a given user or other measures. Additional measures of value may be performed until in step 1608 the final such test for a given segment is performed. In step 1610 the value to the advertiser of the segment is calculated. That calculation may be a simple as averaging the LTV for all users in the segment, or may be much more complex, involving weighted combinations of the results of multiple tests. In step 1612 it is determined whether additional segments are to be similarly evaluated. If so, the process repeats starting with step 1602 for the next segment; if not, in step 1614 the process ends.

Multiple iterations of the process described in FIG. 16 leads to a fundamentally different result as compared to existing approaches to performance-based advertising for virtual goods and services. Rather than bringing to the advertising market a single per-user price the buyer is willing to pay, a buyer can arrive at a large number of appropriate maximum purchase prices for specific kinds of users and specific ads targeting those users. This ability brings major benefits. With a single, one-size-fits-all price, a buyer will virtually always be overpaying for some of the users it acquires, since at best the single price will almost certainly be too high for some users while (hopefully) being a bargain for others. With sufficiently large data sets and carefully tailored “more like this” requests, a buyer will be able to match the price it is willing to pay for a user to that user's value, and thus greatly reduce or even substantially eliminate the likelihood of paying more for a user than that user will generate in benefits to the advertiser.

One way of applying this technology to increase efficiency is to greatly shorten the duration of the required feedback loop when deploying and evaluating customer acquisition strategies. Existing analytical techniques generally require that conclusions about the effectiveness of a specific ad campaign can be drawn only after (a) the completion of the campaign and (b) enough time has elapsed so that the LTV (or other measure of value) can be observed. Because LTV means “long term value,” this necessarily implies that feedback loops are also long. But when a game or other application is paying money for each acquired user, the waste involved in running a campaign long and large enough to achieve statistical significance can be considerable. The cost and commitment required in order to test a campaign that way can lead vendors to limit testing, lead them to make only small and cautious changes to customer acquisition strategies, or otherwise contribute to wasteful allocation of resources.

In contrast, the subject invention can be used to both reduce the cost of testing and to permit a vendor to recognize the cost effectiveness of a given campaign much earlier. This permits vendors to run multiple simultaneous ad campaigns, iterate quickly and to discontinue inefficient campaigns before those campaigns have expended significant resources (and perhaps attracted large numbers of users who will continue to use the game or service without generating revenue).

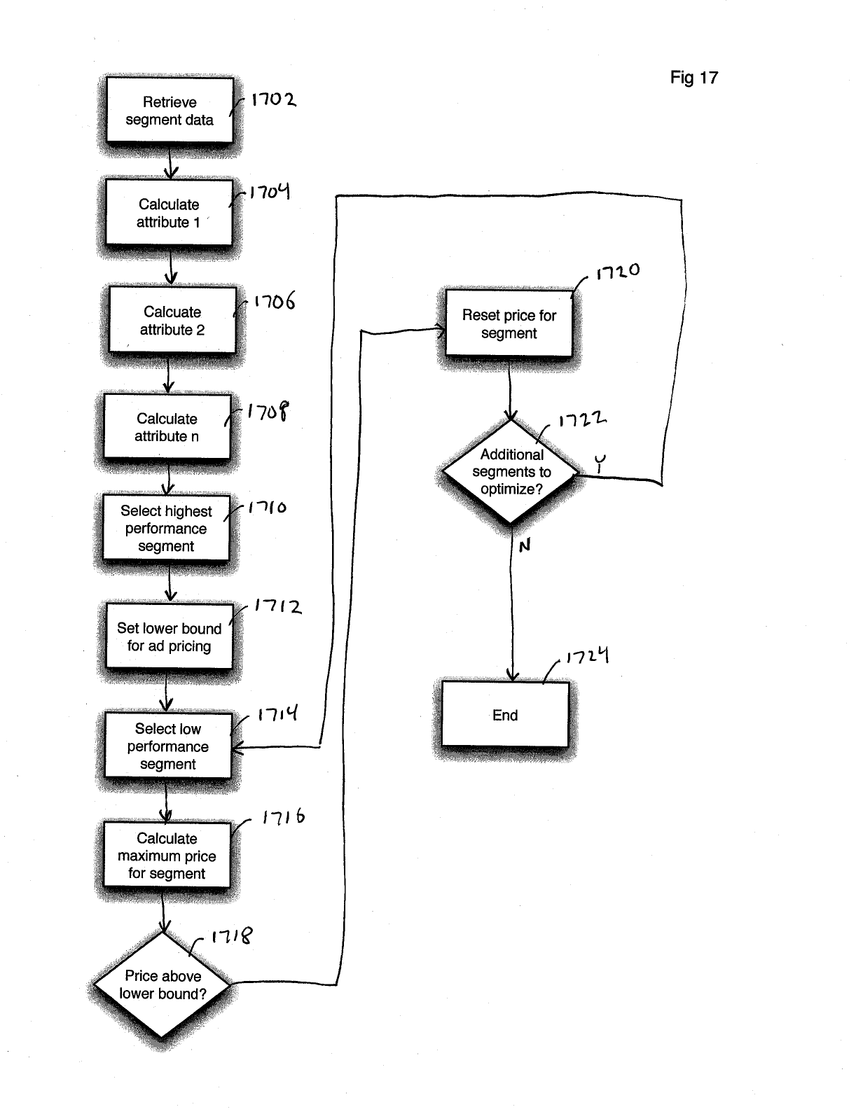

FIG. 17 illustrates the steps involved in one application of the subject invention to reduce waste in customer acquisition. In step 1702 the subject invention retrieves segment data for the population(s) of users to be evaluated, such as all of the users acquired in the first ten days of multiple advertising campaigns being run simultaneously and compared for cost-effectiveness. This data will likely include the terms of the specific campaign, including the price the vendor is paying for each user. In step 1704 the values for a specific attribute (for example, ARPU) for each segment are calculated. In step 1706 the values for another specific attribute (such as number of first day purchasers) are calculated. The process continues until in step 1708 the values for the final attribute (for example, the number of purchase transactions relative to the number of users in the segment) have been calculated. In step 1710, the values generated in the previous steps are used to determine the segment with the highest performance, such as by calculating the ratio of the price paid per user to the anticipated average long term value of the customers in that segment as predicted by the available data. This segment may be used in following steps as a baseline, and the prices the vendor will be willing to pay for users in other, lower performing segments will be adjusted in order to at least equal efficiency of the best performing segment. In essence, the subject invention operates on the assumption that a game or other intangible product will achieve better results with some segments than with others. The subject invention can improve the performance of specific segments by intelligently and automatically altering the maximum prices the vendor should pay to acquire customers in those segments. It may be the case, for example, that the highest price a particular game provider will be willing to pay for customers in rural France with 2-year old Android phones is below the price a seller of ads targeted to those users is willing to accept. In such a case, the game provider would simply transfer the customer acquisition budget previously directed to that segment to a different segment that offered better performance. For a given set of segments, it is possible that eventually there will be a single segment that will become the only one that the ad buyer will target for customer acquisition.

Thus having determined, that, for example, frequent game players with the most recent iPhone who live in the US produce the most revenue relative to their acquisition cost among all segments, then the subject invention proceeds to evaluate and optimize each of the remaining segments. In step 1712 the lower bound for reduced pricing is established—that is, the minimum pricing to be allowed for any segment (it may be the case that overhead associated with transaction costs, or with servicing a customer account could make acquiring a user uneconomical even at a price of zero). In step 1714, one of the segments other than the highest performing segment is selected. In step 1716, the maximum price in order for that segment to match the performance of the highest performing segment is calculated. For example if the calculated value of the users in the segment being evaluated is one-half of the value of the users in the exemplary segment, then the price paid for a user in the segment being evaluated should be no more than one-half of the price paid for users in the exemplary segment. In step 1718 it is determined whether the calculated maximum price for that segment is above the lower bound. If not, the routine will end for that segment, no further acquisition efforts will be pursued for that segment, and the next segment is evaluated. If it is still higher, then in step 1720 the price for the specific segment being optimized is reset to the price calculated to match the performance of the segment identified in step 1716. In step 1722 it is determined whether there are additional segments to be evaluated. If so, the process repeats starting with step 1714. If not, the process ends.

The process described in FIG. 17 can be periodically repeated in order to further optimize customer acquisition. As segmentation criteria evolve, it is likely that a new exemplar for efficiency will be discovered, and thus all other segments, including the previous exemplar, will be inferior and require adjustment.

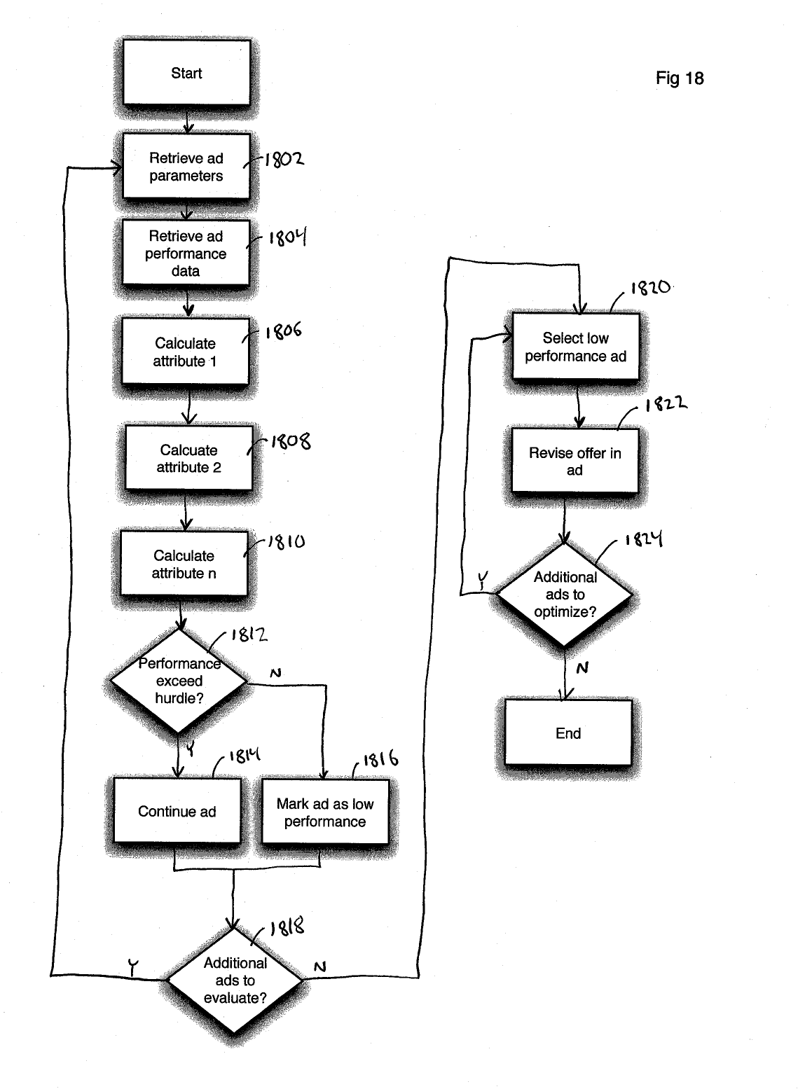

FIG. 18 illustrates the steps involved in applying the subject invention to optimize the size of an offer of free virtual goods in an advertisement for a game for computers or mobile devices by automatically measuring the financial impact of different offers, determining which offers maximize returns, and implementing those value in future ads.

In step 1802, the parameters of the first ad to be evaluated are retrieved. Parameters may include the value of the free offer in the ad, where the ad was placed, etc. In step 1804 the performance data for the ad is retrieved. Such performance data may include specific s about customers who downloaded the game or service after seeing the ad such as when they played/used the service, when they spent and how much, whether and when they contributed to virality by encouraging others to play the game or use the service, etc. In step 1806, the first metric for the performance of the ad is calculated. That attribute may be actual long-term value, if the analysis is performed long enough after the running of that ad the long term value is known, or it can be predicted long-term value, as discussed previously, or it may be some other relevant metric. In step 1808, a second metric for the performance of the ad is calculated. That attribute may be a measure of the number of users/players obtained as a result of activation of the users obtained from the ad, or some other measure. In step 1810, the final metric for the performance of the ad is calculated. Additional or different tests may be performed.

In step 1812, the calculated results are compared to the relevant metrics in order to determine whether the performance of the ad being evaluated I high enough to justify continuation of the ad campaign. Thus if, for example, a given game has set a projected per-paying user LTV of $15 as the most significant hurdle, and a given ad has produced $18 per paying user, then no action to change the ad strategy or the value of the free offer in the ad is necessary, and in step 1814 the ad is slated to continue to run. If the ad does not clear the chosen hurdle or hurdles, however, then in step 1816 it is marked as a low performer, and is optimized as discussed below. In step 1818 it is determined whether there are additional ads to evaluate. If so, the process repeats starting from step 1802; if not, the next phase of the process begins.

Once the evaluation process is complete, in step 1820 one of the low-performing ads is selected for optimization. In step 1822 the specific terms of the in-ad offering are revised. The specific changes will depend up the metrics being applied and the kind of underperformance detected. If, for example, analysis showed that LTV for players acquired through a specific ad is reasonable, but that the players take much longer than other users to purchase in-application currency, it may be appropriate to reduce the size of the bundle of free currency offered in the ad. If LTV is low because very few players are acquired, it may be appropriate to increase the size of the free currency bundle.

In step 1824, it is determined whether there are additional ads to be optimized. If so, the optimization process resumes for the next ad with step 1820. If not, the process ends.

What is claimed is:

1. A method for managing the allocation of advertising for a game on a mobile device, comprising:
evaluating a plurality of attributes of a plurality of existing users of said online game;
using said plurality of attributes to divide said plurality of existing users into a plurality of segments;
identifying at least a segment of said plurality of said users that is correlated with high performance in at least a category of user behavior relative to other segments of users;
creating at least a profile of said users comprising said segment correlated with high performance; and
placing advertisements in order to maximize the acquisition of new users comprising that segment.

2. A method as in claim 1 in which the segment of said plurality of users that is correlated with high performance in at least a category of user behavior relative to other subsets of users is geographically determined.

3. A method as in claim 1 in which the segment of said plurality of users that is correlated with high performance in at least a category of user behavior relative to other subsets of users is related to the specific mobile device associated with said users.

4. A method as in claim 1 in which the segment of said plurality of users that is correlated with high performance in at least a category of user behavior is related to an aspect of the purchasing behavior of said segment.

5. A method as in claim 1 in which the advertisements are placed in games for mobile devices.

6. A method as in claim 1 in which the category of user behavior in which a segment of users demonstrates high performance is purchasing virtual goods.

7. A method as in claim 1 in which said mobile devices are smart phones.

8. A method as in claim 1 in which the segment of said plurality of users that is correlated with high performance in at least a category of user behavior relative to other subsets of users is related to the percentage of said users who have made multiple purchases of real or virtual goods within said online game.

9. A method as in claim 1 in which the segment of said plurality of users that is correlated with high performance in at least a category of user behavior relative to other subsets of users is related to specific content of an advertisement displayed to said segment of said plurality of users.

10. A method as in claim 1 in which the segment of said plurality of users that is correlated with high performance in at least a category of user behavior relative to other subsets of users is related to the predicted long term value of said segment of said plurality of users.

11. A system for increasing the number users who install a game on a mobile device, comprising:
a first application running on a first device comprising computer hardware, wherein said device is in communication with a network;
a second application running on a plurality of second devices comprising computer hardware, wherein said second devices are in communication with said first device over said network;
wherein said first application evaluates a plurality of attributes of a plurality of existing users of said online game on said second devices;
wherein said first application uses said plurality of attributes to divide said plurality of existing users into a plurality of segments;
wherein said first application identifies at least a segment of said plurality of said users that is correlated with high performance in at least a category of user behavior relative to other subsets of users;
wherein said first application creates at least a profile of said users comprising said segment correlated with high performance;
wherein said first application evaluates the performance of said segment of said plurality of said users that has previously been correlated with high performance; and
wherein said first application creates a profile for desired additional users of said game such that said new users correspond to said segment of said plurality of said users that has previously been correlated with high performance.

12. A system as in claim 11 in which the segment of said plurality of users that is correlated with high performance in at least a category of user behavior relative to other subsets of users is geographically determined.

13. A system as in claim 11 in which the segment of said plurality of users that is correlated with high performance in at least a category of user behavior relative to other subsets of users is related to the specific mobile device associated with said users.

14. A system as in claim 11 in which the segment of said plurality of users that is correlated with high performance in at least a category of user behavior is related to an aspect of the purchasing behavior of said segment.

15. A system as in claim 11 in which advertisements are placed in games for mobile devices.

16. A system as in claim 11 in which the category of user behavior in which a segment of users demonstrates high performance is purchasing virtual goods.

17. A system as in claim 11 in which said mobile devices are smart phones.

18. A system as in claim 11 in which the segment of said plurality of users that is correlated with high performance in at least a category of user behavior relative to other subsets of users is related to the percentage of said users who have made multiple purchases of real or virtual goods within said online game.

19. A system as in claim 11 in which the segment of said plurality of users that is correlated with high performance in at least a category of user behavior relative to other subsets of users is related to specific content of an advertisement displayed to said segment of said plurality of users.

20. A system as in claim 11 in which the segment of said plurality of users that is correlated with high performance in at least a category of user behavior relative to other subsets of users is related to the predicted long term value of said segment of said plurality of users.
